(19) United States
(12) Patent Application Publication
(10) Pub. No.: US 2025/0380239 A1
(43) Pub. Date: Dec. 11, 2025

(54) SIDELINK POSITIONING FOR TARGET UE IN OUT-OF-COVERAGE OR PARTIAL COVERAGE SCENARIOS

(71) Applicant: FRAUNHOFER-GESELLSCHAFT ZUR FÖRDERUNG DER ANGEWANDTEN FORSCHUNG E.V., Muenchen (DE)

(72) Inventors: Birendra GHIMIRE, Erlangen (DE); Mohammad Alawieh, Erlangen (DE); Jochen Zeitz, Erlangen (DE)

(21) Appl. No.: 19/300,853

(22) Filed: Aug. 15, 2025

Related U.S. Application Data
(63) Continuation of application No. PCT/EP2024/053888, filed on Feb. 15, 2024.

(30) Foreign Application Priority Data
Feb. 15, 2023 (EP) 23156940.1

(51) Int. Cl. H04W 64/00; H04L 5/00; H04W 24/08; H04W 92/18

(52) U.S. Cl. CPC H04W 64/00; H04L 5/0051; H04W 24/08; H04W 92/18

(57) ABSTRACT

An embodiment provides a server UE, especially UE acting as positioning session coordinator, having a transceiver and a controller,
wherein the transceiver is configured to receive positioning request (from its higher layers or from a second entity),
wherein the controller is configured
to initiate and/or maintain a positioning session for a target UE, wherein the positioning session has at least a measurement between the target UE and an anchor UE; to select out of a plurality of UEs at least one anchor UE fulfilling one or more anchor UE selection criteria; and
to coordinate assignment of the configuration associated with at least one resource for transmission and/or for reception with the target UE and the anchor UE involved in the positioning session.

### CROSS-REFERENCE TO RELATED APPLICATIONS

This application is a continuation of copending International Application No. PCT/EP2024/053888, filed Feb. 15, 2024, which is incorporated herein by reference in its entirety, and additionally claims priority from European Application No. 23156940.1, filed Feb. 15, 2023, which is also incorporated herein by reference in its entirety.

### TECHNICAL FIELD

Embodiments of the present invention refer to a server UE, target UE and anchor UE, all participating or supporting positioning sessions. Further embodiments provide corresponding methods and communication systems. Embodiments refer to Sidelink positioning for target UE in out-of-coverage or partial coverage scenarios.

### BACKGROUND OF THE INVENTION

FIG. 20 is a schematic representation of an example of a terrestrial wireless network 100 including, as is shown in FIG. 20(a), the core network 102 and one or more radio access networks RAN₁, RAN₂, . . . . RAN_{N}. FIG. 20(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 20(b) shows an exemplary view of five cells, however, the RANₙ may include more or less such cells, and RANₙ may also include only one base station. FIG. 20(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands.

Further, FIG. 20(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UEs as is schematically represented by arrow 112₂. The respective base station gNB₁ to gNB₅ may be connected to the core network 102, e.g., via the S1 interface, via respective backhaul links 114₁ to 114₅, which are schematically represented in FIG. 20(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 20(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 20 may be a heterogeneous network having distinct overlaid networks, e.g., a network of macro cells with each macro cell including a macro base station, like base station gNB₁ to gNB₅, and a network of small cell base stations, not shown in FIG. 20, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 20, for example in accordance with the LTE-Advanced Pro standard or the 5G or NR, new radio, standard.

In mobile communication networks, for example in a network like that described above with reference to FIG. 20, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 20. This is referred to as an “in-coverage” scenario. Another scenario is referred to as an “out-of-coverage” scenario. It is noted that “out-of-coverage” does not necessarily mean that the two UEs are not within one of the cells depicted in FIG. 20, rather, it may also mean that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

Furthermore, a UE in “out-of-coverage” may establish its signaling connection through a second UE in “in-coverage” scenario, this scenario is referred to as “partial coverage scenario”.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 21 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 20. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 22 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 22 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 21, in addition to the NR mode 1 or LTE mode 3 UEs 202, 204 also NR mode 2 or LTE mode 4 UEs 206, 208, 210 are present. In addition, FIG. 22, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 21 and FIG. 22 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

It is an objective of the present invention to improve coordination of positioning sessions, especially using sidelink communications.

### SUMMARY

An embodiment may have a target UE acting as positioning session coordinator and target UE, having a transceiver and a controller, wherein the transceiver is configured to receive positioning request (from its higher layers or from a second entity), wherein the controller is configured to create and/or maintain a positioning session for a target UE, wherein the positioning session has at least a measurement between the target UE and an anchor UE; to select out of a plurality of UEs at least one anchor UE fulfilling one or more anchor UE selection criteria; to coordinate assignment of at least one resource for transmission and/or for reception with the target UE and the anchor UE involved in the positioning session, wherein coordinating assignment has exchanging resource information on at least one resource to be used for transmitting and/or receiving a positioning reference signal; wherein the target UE is configured to participate in a positioning session.

Another embodiment may have a target UE, having a transceiver and a controller, herein the transceiver is configured to receive positioning request (from its higher layers or from a second entity), wherein the controller is configured to create and/or maintain a positioning session for a target UE, wherein the positioning session has at least a measurement between the target UE and an anchor UE; to select out of a plurality of UEs at least one anchor UE fulfilling one or more anchor UE selection criteria to coordinate assignment of at least one resource for transmission and/or for reception with the target UE and the anchor UE involved in the positioning session, wherein coordinating assignment has exchanging resource information on at least one resource to be used for transmitting and/or receiving a positioning reference signal; wherein the transceiver is configured to participate in a positioning session.

Another embodiment may have an anchor UE having a transceiver, wherein the transceiver is configured to exchanges information with another UE so as to coordinate with the another UE acting as positioning session coordinator, wherein the information has one or more anchor UE selection criteria and/or at least one resource where the UE is able to transmit and/or receive sidelink positioning reference signals; and/or wherein the information has a configuration, wherein the configuration indicates at least one resource configured by the other UE where it is configured to transmit and/or receive positioning reference signals; and/or wherein the transceiver is configured to transmit and/or receive a reference signal for the positioning session using the at least one configuration an information on which is exchanged; and/or wherein the transceiver is configured to transmit and/or receive a reference signal so as to participate in a positioning session, wherein the anchor UE associates at least two messages associated with the positioning of the target UE to a positioning session maintained by the other UE.

Another embodiment may have a server UE, especially UE acting as positioning session coordinator, having a transceiver and a controller, wherein the transceiver is configured to receive positioning request (from its higher layers or from a second entity), wherein the controller is configured to initiate and/or maintain a positioning session for a target UE, wherein the positioning session has at least a measurement between the target UE and an anchor UE; to select out of a plurality of UEs at least one anchor UE fulfilling one or more anchor UE selection criteria; and to coordinate assignment of the configuration associated with at least one resource for transmission and/or for reception with the target UE and the anchor UE involved in the positioning session.

According to another embodiment, a system may have a server UE according to the invention as mentioned above and/or a target UE according to the invention as mentioned above and at least one anchor UE according to the invention as mentioned above.

According to another embodiment, a method for operating a target UE, especially UE acting as positioning session coordinator and target UE, may have the steps of: receiving positioning request (from its higher layers or from a second entity), creating and/or maintaining a positioning session for a target UE, wherein the positioning session has at least a measurement between the target UE and an anchor UE; selecting out of a plurality of UEs at least one anchor UE fulfilling one or more anchor UE selection criteria; coordinating assignment of at least one resource for transmission and/or for reception with the target UE and the anchor UE involved in the positioning session, wherein coordinating assignment has exchanging resource information on at least one resource to be used for transmitting and/or receiving a positioning reference signal; participating in a positioning session.

According to another embodiment, a method for operating a server UE, especially UE acting as positioning session coordinator, may have the steps of: receiving positioning request (from its higher layers or from a second entity), initiating and/or maintaining a positioning session for a target UE, wherein the positioning session has at least a measurement between the target UE and an anchor UE; selecting out of a plurality of UEs at least one anchor UE fulfilling one or more anchor UE selection criteria; and/or coordinating assignment of the configuration associated with at least one resource for transmission and/or for reception with the target UE and the anchor UE involved in the positioning session.

Another embodiment may have a method for operating a target UE having providing in response to a started positioning session information on one or more anchor UE selection criteria and to participate in a positioning session.

According to another embodiment, a method for operating anchor UE may have the steps of: exchanging information with another UE so as to coordinate with the another UE acting as positioning session coordinator, wherein the information has one or more anchor UE selection criteria and/or at least one resource where the UE is able to transmit and/or receive positioning reference signals; and/or wherein the information has a configuration, wherein the configuration indicates at least one resource configured by the other UE where it is configured to transmit and/or receive sidelink positioning reference signals; and/or transmitting and/or receiving a reference signal for the positioning session using the at least one configuration an information on which is exchanged; and/or transmitting and/or receiving a reference signal so as to participate in a positioning session, wherein the anchor UE associates at least two messages associated with the positioning of the target UE to a positioning session maintained by the other UE.

Still another embodiment may have a computer program for performing one of the above methods according to the invention.

Below, background of embodiment of the present invention will be discussed, wherein it is clear, that the discussion of the background belongs to the invention.

UE positioning consists of determining one or more location dependent parameters (e.g. position, range, velocity, proximity . . . etc.) for a target UE. The UE positioning could be done on a best effort basis or with a certain quality of service requirement. The quality of service may be associated with the requirement corresponding to an application.

The key issue to be solved with this application is how a UE may interact with one or more UEs and/or network elements to enable delivering a location service with a desired quality of service requested, when ranging between one or more UEs is enabled. The invention discloses functionality of UE when acting under one or more roles, the coordination and signaling needed to enable UE positioning with a certain quality of service using at least one sidelink reference signal as a mean to estimate location dependent parameters.

In embodiments of this invention, the term positioning encompasses absolute positioning and relative positioning. In absolute positioning, position and/or velocity is/are determined for a target UE on a certain coordinate system (local or global) whereas in relative positioning, the range and/or angle between the target UE and an anchor UE may be determined.

An embodiment provides a server UE, especially UE acting as positioning session coordinator, comprising a transceiver and a controller, wherein the transceiver is configured
to receive positioning request (from its higher layers or from a second entity), wherein the controller is configured
to initiate and/or maintain a positioning session for a target UE, wherein the positioning session comprises at least a measurement between the target UE and an anchor UE;
to select out of a plurality of UEs at least one anchor UE fulfilling one or more anchor UE selection criteria; and
to coordinate assignment of the configuration associated with at least one resource for transmission and/or for reception with the target UE and the anchor UE involved in the positioning session.

According to an embodiment the server UE is configured to receive at least a measurement from at least an anchor and a target, and use the measurement for monitoring and/or computing position of the target UE.

According to an embodiment the server UE is configured to reselect anchors and/or reconfigure transmit and receive positioning resources for target UE, dependent on the measurement results.

According to an embodiment the server UE is configured to report back to the entity requesting the location of the target UE, where the report consists at least of the requested location service.

According to an embodiment the server UE is configured to report back to the entity requesting the location of the target UE, where the report further contains indication of achieved QoS parameter and/or a flag indicating whether the QoS service was met.

According to an embodiment, the request comprises a discovery message or positioning session establishment request; for example, the transceiver may be configured to respond to a discovery message by use of a discovery response message if the server UE is capable of acting as positioning session coordinator or to respond to a positioning session establishment request by use of a positioning session establishment response if the server UE has created a positioning session.

According to an embodiment, the server UE is selected out of a plurality of UEs by a network entity, like the base station and/or location management function and/or access and mobility function, configured or pre-configured to act as a server UE; for example, the selection may be done by using assistance data provided by the network via another UE in coverage, wherein the assistance data may indicate the availability of a server UE in a certain validity area; alternatively the selection of the server UE may be performed based on server selection criteria out of the following:
pre-configured and/or configured by the network;
Location (absolute or relative) of the server UE to be selected;
selected by the target UE taking into account its own location;
mobility state of the target UE and/or server UE to be selected;
group membership of a group or moving group comprising the target UE and the server UE to be selected
association to same serving PLMN, to same type of service as indicated by application layer, to same OEM, etc;
synchronization reference of the server UE (SyncRef UE);
Energy considerations at the server UE;
Coverage and/or connectivity state of the server UE;
Number of anchors currently managed by the UE;
DOP value for a given location;
Latency values on signalling link;
QoS classes pertaining to positioning supported by the server UE;
Support of session handover by the server UE;
Condition that the server UE is in coverage or in partial coverage.

According to an embodiment, the request is sent as broadcast and/or groupcast messages by the target UE or as discovery message sent by the target UE; the transceiver may be configured to respond to the request, especially by providing a capability information; and/or wherein the transceiver is configured exchange keys while establishing security.

According to an embodiment, the selection of anchors done by the server UE is based on information of anchor UE already available at the server UE (e.g. from network provisioning, preconfigured and/or configured assistance data, broadcast of information from network and/or anchor UE) or received by the server UE (e.g. assistance data sent by the one or more anchor UEs regarding its position, position accuracy, movement, etc.), where the information comprises a parameter which is used by the UE to select an anchor node or comprises indication to the server UE regarding a capability of another UE to serve as anchor UE.

According to an embodiment, the selection done by exchanging (receiving and/or sending out) a discovery message and/or a session creation request, where the messages indicate the parameters which form part of anchor UE selection criteria, such that the anchors fulfilling the request respond back to the server UE.

According to an embodiment, the one or more anchor UE selection criteria comprise a quality of service parameter; for example, the one or more anchor UE selection criteria may comprise a quality of service parameter and wherein the quality of service parameter comprise one of accuracy, latency, update rate, integrity (protection level, alert limit, time to alert).

According to an embodiment, the anchor UE selection criteria comprise at least one out of a group comprising:
resources; and/or
method for a positioning session to be supported by the anchor UE;
RSRP on certain sidelink reference signal measured by the UE is: Below a configured threshold or above a configured threshold or below a first configured threshold and above a second configured threshold;
physical channel condition especially LOS condition, multipath, signal strength, RSRP measured, Latency observed on a signalling link;
belonging to a group of UEs that transverse through different areas;
within Range of the of the target UE and/or UE acting as positioning session coordinator;
privacy requirements;
security requirements;
Anchor role supported by the UE;
Line of sight condition between the target UE and the anchor UE;
estimate LOS condition based on this discovery signal, and associate the response;
Bandwidth of the positioning reference signal which can be transmitted and/or received by the UE;
Update rate supported by the anchor UE;
intended measurements (e.g. RSTD, RTT, TDOA, ToA, AoA, AoD) supported by the anchor UE;
Capability of the anchor UE to process sidelink measurements;
Location of the anchor UE;
Mobility state of the target UE and/or anchor UE and/or server UE;
Group Membership of the target UE and/or the anchor UE and/or anchor UE;
Synchronization reference of the anchor UE (SyncRef UE);
Energy considerations at the anchor UE;
Coverage and/or connectivity state of the anchor UE;
Latency values on signalling link.

According to an embodiment, the transceiver is configured to obtain at least one positioning measurement from at least one of the target UE and/or the anchor UE involved in the positioning session. For example, in RTT, the session coordinator may receive from both. In single sided RTT or TDOA, it may receive either from anchor or from target (depending on which side is transmitting and receiving).

According to an embodiment, the request includes at least a request for positioning, which may further include at least one quality of service parameter;

According to an embodiment, the request may be received from a network entity, such as LMF or NG-RAN node or application function residing in core network, or another UE without sidelink transmission/reception capabilities, or another UE without sidelink transmission/reception capabilities at least for positioning reference signals, or another UE with sidelink, or a target UE; according to an embodiment, the UE may be configured to respond a target UE indicating its availability to act as positioning session coordinator or to respond a target UE indicating its availability to act as positioning session coordinator, wherein response comprise additional information such as RSRP measured on a reference signal associated with discovery message and/or additional information indicated by a discovery message, processing capability, e.g. number of position fixes per unit time, number of other UEs within its reach, current load, associated area.

Note, the quality of service parameter may comprise an information on one of accuracy, latency, update rate, integrity (e.g. protection level, alert limit, time to alert).

According to an embodiment, the positioning session associates at least two messages exchanged between the positioning session coordinator and at least one other UEs.

According to an embodiment, the creating and/or maintaining a positioning session comprises one of the following:
Monitoring the selection of anchor UE with respect to performance criteria;
Monitoring the selection of anchor UE with respect to performance criteria, wherein the performance criteria are out of a group:
   Monitoring the physical channel conditions between the target UE and the anchor UE (physical channel conditions may be LOS condition, multipath, signal strength)
   Monitoring the signaling connections between the anchor UE and the server UE (RSRP measured on at least one reference signal on a signalling link, Latency observed on a signalling link)
   Monitoring the geographical location of target and/or anchor (e.g. the angle between the target UE and the anchor UE);
Adding or removing an anchor involved on positioning session, based on the result of monitoring and/or monitoring outside the session;
Discovering a UE that can act as an anchor UE (note, the discovering may be performed, for example, by the UE that takes the tole of the target UE or a target UE acting as positioning session coordinator or the server UE; thus, discovering is typically done when s target UE and server UE are collocated or defined);
Establishing secure (security and integrity protected) connection on signalling links;
Checking the whether the anchor UE is allowed to range with the target UE and/or vice versa;
Configuring the anchor UE to perform reporting, either on a periodic, based on a trigger or event-driven based on measurement;
Allocating or determining resources for the anchor UE and/or the target UE and/or interacting with the anchor UE and/or the target UE to identify a configuration of resource for performing channel measurement between two UEs;
performing measurement on resource pools configured and/or preconfigured to contain sidelink positioning reference signal.

According to an embodiment, the coordinating assignment comprise one of the following:
Providing at least one configuration to at least one UE, where the configuration indicates at least the time frequency resources such as bandwidth and periodicity.
Reconfiguring the provided configuration of transmit and/or receive resources provided to the UE.
Reconfiguring if the link becomes weak, for example, the update rate may be reduced and reporting disabled from the receiver until the link quality becomes better again.

According to an embodiment, maintaining a positioning session comprise (when entering a new area) monitoring and receiving information from one or more UE to act as anchor UEs, especially comprising monitored information (w.r.t. changed parameters), and/or triggering one or more anchor UEs to perform a measurement and/or monitoring and to provide a report on the measurement and/or monitoring.

According to an embodiment, the controller is configured for one of the following:
Providing at least one UE the configuration to transmit and/or receive sidelink positioning signals;
associating at least two messages exchanged between the positioning session coordinator and at least one other UE,
monitoring the selection of anchor with respect to certain performance criteria.
adding or removing an anchor involved on positioning session, based on the result of monitoring and/or monitoring outside the session;
Reconfiguring the provided configuration of transmit and/or receive resources provided to the UE;
Initiating discovery procedure for discovering at least one target UE and/or at least one anchor UE;
Establish secure link (integrity protected and/or ciphered) for transmitting signalling messages between the session coordinator UE and at least one other UE;
Receiving the report from at least one other UE regarding the resource occupancy observed by the said UE;
Monitoring signaling latency between itself and another UE;
Checking whether the LCS client is allowed to make request regarding the target UE, by interacting with higher layer or with location server;
Checking whether the anchor UE is allowed to range with the target UE;
Providing an identifier, with which the messages from a positioning session can be identified by a second entity (e.g. a UE and/or a network entity)
Determining a position based on the measurements obtained from at least one other UE;
Provide the location service to the LCS client;
Discovering at least one server UE, and handing over to the server UE, advantageously before the target UE loses connectivity with the server UE;
Creation of a session for a given target UE;
Adding anchor UEs;
Removing anchor UEs;
Adding configuration pertaining to transmission and/or reception for a UE;
Establishing quality-of-service constraints with one or more UEs;
Assigning priorities to transmission and/or reception of positioning reference signals;
Acting as assistant UE (attempt to perform ranging with the second UE if its identifier is known or use a configuration of resource in a discovery pool, transmit pool or exceptional pool to attempt to range with another UE);
announcing its capabilities to act as a positioning session coordinator UE.

According to an embodiment, the server UE is formed by a separate server UE (variant 2) or a target UE (variant 1) or an assistant UE.

According to an embodiment, the server UE is requested and/or selected by target UE; for example, the server UE is selected under the condition that the target as well as the anchor UE are configured to communicate with the UE acting as positioning session coordinator and/or taking into account privacy/security demands.

Another embodiment provides a target UE, especially UE acting as positioning session coordinator and target UE, comprising a transceiver and a controller, wherein the transceiver is configured to receive positioning request, e.g. from its higher layers or from a second entity,

wherein the controller is configured to create and/or maintain a positioning session for a target UE, wherein the positioning session comprises at least a measurement between the target UE and an anchor UE; to select out of a plurality of UEs at least one anchor UE fulfilling one or more anchor UE selection criteria; to coordinate assignment of at least one resource for transmission and/or for reception with the target UE and the anchor UE involved in the positioning session, wherein coordinating assignment comprises exchanging resource information on at least one resource to be used for transmitting and/or receiving a positioning reference signal; wherein the transceiver is configured to participate in a positioning session. According to embodiments, participating in a positioning session means that the target performs a measurement on a provided reference signal or provides a reference signal for a measurement. The measurement forms the basis to determine the position of the target UE (positioning) or to determine a distance to the target UE (ranging).

According to embodiments, the target UE may provide a session identifier on the first message to a second UE. The responding UE (e.g. the anchor UE) is, thus, enabled to respond back using the same session identifier, so the target UE and the anchor UE participate in the positioning session (initiated by the target UE). This positioning session is identified by the session identifier. Below exemplary details for the session identifier are given:
1) The session identifier, which identifies a sidelink positioning session for a target UE, may be allocated by the UE which receives the location request from its higher layer or from a second entity. The session identifier is used to associate the measurements pertaining to a particular target UE.
   If the LCS request for the target UE is received by the server UE from another entity, then the server UE assigns the session identifier and includes it in the SLPP message sent to the target UE. All target UEs and anchor UEs include this session identifier to help server UE identify the measurements pertaining to the target UE.
   In case the target UE receives the LCS request from a second entity or from its higher layers, then the target UE assigns the session identifier, and includes it in the SLPP message sent to other UEs. All UEs participating in the positioning session use the session identifier assigned by the target UE, to uniquely identify messages within this session.
   In case the target UE is involved in sidelink positioning with the LMF, then the target UE assigns the session identifier and includes it in the SLPP message sent to the anchor UE and LMF. All target UEs and anchor UEs include this session identifier, when providing measurement to the LMF, to help LMF identify the measurements pertaining to the target UE.

The session ID may be an identifier consisting of a sequence of bits that are assigned by the UE. The assignment may be done by the application layer running on the UE and/or the ID may be provided by the layer running the sidelink positioning protocol. It may be possible that the identifier is based on whole or part of identity of the UE or the group where the UE belongs or combination thereof. For example, the identifier may take certain number of bits from the Layer-2 ID of the source/destination of the target UE or parts of the group membership of the UE, part of the application layer ID, or part of any other identity of the UE, or combinations thereof. Alternatively, the identifier may be provided by the application layer of the UE or provided by a server on the network side.

Another embodiment provides a target UE comprising a transceiver, wherein the transceiver is configured to provide in response to a started positioning session information on one or more anchor UE selection criteria and to participate in a positioning session.

According to an embodiment, the transceiver of target UE is configured to sent a request to a server UE to be selected as broadcast and/or groupcast message(s) (broadcast and/or groupcast message sent by the target UE) or as discovery message (sent by the target UE); and/or

wherein the target UE is configured to select the server UE or itself as server UE based on a configuration or per-configuration or assistance data provided by the network via another UE in coverage, wherein the assistance data may indicate the availability of a server UE in a certain validity area or based on server selection criteria out of the following:
pre-configured and/or configured by the network;
Location (absolute or relative) of the server UE to be selected (for example, the location may be related to the question whether UE is in coverage or not, since this describes the UE's location; background is that the UE's information including whether UE is in coverage or not;
selected by the target UE taking into account its own location (UE location);
mobility state of the target UE and/or server UE to be selected;
group membership of a group or moving group comprising the target UE and the server UE to be selected; note the group membership previously discussed in context of server UE selection and/or server UE may, of course, be used as selection criterion for a target UE which should act as coordinator. PLMN (Public Land Mobile Network) could be one of them;
association to same serving PLMN, association to same type of service as indicated by application layer, association to UEs from same OEM, etc; for example, the target UE shall discover and select a SL Positioning Server UEs that are in the same or different serving PLMN of the target UE and the SL Reference UEs;
synchronization reference of the server UE (SyncRef UE);
Energy considerations at the server UE; for example, the server UE may not be selected if the battery level is below a certain threshold value configured by the network;
Coverage and/or connectivity state of the server UE; for example, the UE's information may include whether UE is in coverage or not;
Number of anchors currently managed by the UE;
DOP value for a given location;
Latency values on signalling link;
QoS classes pertaining to positioning supported by the server UE;
Support of session handover by the server UE; Condition that the server UE is in coverage or in partial coverage.

According to an embodiment, target UE is configured to be authorized to act as a server UE for a given target UE or to obtain an authorization for the target UE to select a certain server UE as its positioning server and/or to participate or initiate a security establishment procedure; for example, the target UE is configured to initiate the positioning session, especially by sending a request or selecting a server UE, and/or to repeat the initiation of the positioning session, e.g. with another server UE, upto fulfilling a server selection criteria or upon received response from the server UE; and/or

wherein the transceiver is configured to transmit a request or a discovery massage or a positioning session establishment request or a positioning session establishment request as response to a discovery response massage and/or to receive a discovery response massage from a server UE if the server UE is capable of acting as positioning session coordinator or positioning session establishing response if the server UE has created a positioning session.

According to an embodiment the transceiver of a target UE or a target UE is configured to perform at least one of the following in order to participate in the positioning session.
Receiving response from at least one of the second UE, wherein the response of second UE indicates at least one parameter indicating the performance and/or quality parameter supported by second UE with respect to session management capabilities;
Creating a secure link (integrity protected and/or ciphered) for transmitting signaling message between the session coordinator UE and itself;
Monitoring the usage of resources and/or providing information to at least one other UE regarding the resource occupancy observed by the target UE;
Receiving a request from the coordinating UE, on behalf of a second entity, wherein the target UE either accepts or rejects the location request from the session coordinator;
Discovering at least one server UE handling the positioning session on behalf of the target UE, and selecting one UE to manage its positioning session;
Acting as assistant UE (attempt to perform ranging with the second UE if its identifier is known or use a configuration of resource in a discovery pool, transmit pool or exceptional pool to attempt to range with another UE);
performing measurement on resource pools configured and/or preconfigured to contain sidelink positioning reference signal.
assigning the session identifier and including it in the SLPP message sent to the anchor UE.
providing the session identifier to other UEs and LMF, so that the LMF is able to associate the measurements from other anchor UEs or server UEs to the measurement pertaining to the target UE, where the positioning calculation is done at the LMF side.
using the session identifier received from a second UE in all of the messages exchanged between the target UE and the second UE, which may be an anchor UE or a server UE, so that the messages associated with the positioning of the said target UE can be distinguished from the messages associated with positioning of other UE.

According to an embodiment, monitoring is performed so as to find one or more UE acting as positioning session coordinator and/or anchor(s), especially by
making use of pre-configured assistance data or pre-configured configuration data or pre-configured validity condition information, and/or
sending request to one or more UE acting as positioning session coordinator; and/or
sending request to one or more UE acting as positioning session coordinator to-create and/or maintain a positioning session with an anchor UE or the add/deactivate/change an anchor UE in the positioning session; and/or
sending discovery message so as to find one or more UE acting as positioning session coordinator, especially sending discovery message transmitted in PSSCH where the SCI contains a Layer-2 Destination ID used to identify the UE with positioning session coordinator or server UE roles.

According to an embodiment, the transceiver is configured to initiate a positioning session or a sessionless ranging and/or positioning operation using configured or pre-configured assistance data, wherein the assistance data at least describes a configuration of reference signal and/or a resource within a resource pool carrying a reference signal; for example, assistance data may comprise one of the following location of the anchor UE (e.g. coordinates in local or global coordinates), information indicating the motion status of the anchor UE (e.g. in motion or stationary, or velocity), or information about positioning server UE and/or an assistant UE, or configuration of reference signals, or configuration of resources in transmit/receive/discovery/exceptional pool, or validity information of the provided assistance data (e.g. validity area and/or validity time and/or validity conditions or information regarding the transmit and receive pools configured for a UE within a sidelink bandwidth part); note, the assistance data may be assigned to an area and/or are to be used by an UE/group of UEs being or traveling through the area; wherein validity condition information comprising any one of the following V2X Area, Portion of a cell, Group of cells, spatial validity, temporal validity, validity based on measurement conditions.

According to an embodiment, the transceiver is configured to communicate with two different server UE managing two different poisoning sessions and/or participate at different poisoning sessions.

According to an embodiment, the target UE is configured to act as anchor UE for the current positioning session and/or for another UE acting as target UE.

Another embodiment provides an anchor UE comprising a transceiver, wherein the transceiver is configured to exchange information with another UE so as to coordinate with the another UE acting as positioning session coordinator, wherein the information comprises one or more anchor UE selection criteria and/or at least one resource where the UE is able to transmit and/or receive sidelink positioning reference signals; and/or wherein the information comprises a configuration, wherein the configuration indicates at least one resource configured by the other UE where it is configured to transmit and/or receive positioning reference signals; and/or wherein the transceiver is configured to transmit and/or receive a reference signal for the positioning session using the at least one configuration an information on which is exchanged; and/or wherein the transceiver is configured to transmit and/or receive a reference signal so as to participate in a positioning session, wherein the anchor UE associates at least two messages associated with the positioning of the target UE to a positioning session maintained by the other UE.

According to an embodiment, the anchor UE is configured to send or broadcast or unicast information, especially assistance information regarding its position, position accuracy, and/or movement, etc., to be used by the server UE as part of the anchor UE selection criteria or as indication to the server UE regarding its capability to serve as anchor UE.

According to an embodiment, an information, especially assistance information regarding its position, position accuracy, and/or movement, etc., to be used by the server UE as part of the anchor UE selection criteria or as indication to the server UE regarding its capability to serve as anchor UE is transmitted or broadcasted by a network entity or a UE being part of the position session; alternatively, an information to be sent or broadcasted or unicasted within the network comprises at least one of:
Position of the UE;
Position covariance of the UE;
Velocity estimate of the UE;
Sensor data (e.g. Accelerometer, Magnetometer, Tachometer);
Configuration of reference signal used for detecting the anchor UE (e.g. used for monitoring);
Transmit and/or reception pools of UE.

According to an embodiment, the anchor UE is configured is controlled by the server UE for or configured for performing a ranging to another anchor UE or measurement as part of the positioning session to another anchor UE.

According to an embodiment, the anchor UE is configured to perform at least one of the following:
Establishing secure link (integrity protected and/or ciphered) for transmitting signaling messages between the session coordinator UE and at least one other UE;
Monitoring the link between the target UE and itself with respect to at least one quality criteria;
Monitoring the link between the UE coordinating the session and itself with respect to at least one quality criteria;
Monitoring the usage of resources and/or providing information to at least one other UE regarding the resource occupancy observed by the anchor UE;
indicates its availability to act as an anchor for a positioning session either in response to a request from the session coordinator;
Sending a detach request to the session coordinating entity, as a result of monitoring. or due to change in traffic activity in the target UE (e.g. target UE requiring to handle high priority traffic).

According to embodiments, the resources/configuration for the target UE or anchor UE used for the positioning session is configured by the positioning session coordinator or pre-configured.

According to embodiments, the target UE and/or the anchor UE are configured to monitor certain type of information is or resources in a receive resource pool configured for a UE configured with a certain Layer-2 Destination ID; for example the Layer-2 Destination ID may be based on type of service; area; UE-identifier; session ID; group ID; function and/or UE-role. The Layer-2 Destination ID and/or the Layer-2 Source ID may additionally be obtained from the higher layer (e.g. application layer), obtained by quering a second entity (e.g. a database in the network, a network function, a network node) or a second UE.

Another embodiment provides a (communication) system comprising a server UE and/or a target UE and at least one anchor UE.

It should be noted, that features discussed in context of one entity/UE, e.g. the server UE may also be used for another entity/UE, namely its counterpart UE, like the anchor UR or target UE, and vice versa. The features may be used in the same or similar manner. For example, the information provided by the one entity for configuration may be used by the other entity/UE to be configured.

Some functions discussed in context of a certain component may also be implemented differently, i.e. implemented in a different component of the device or the device itself.

According to embodiments each UE may take one or more different roles during a positioning session or change its role (e.g. target→anchor or vice versa) or server→target or vice versa) during active positioning session.

According to embodiments, at least one of or all of the UEs comprising server UE, target UE and one or more anchor UE are out of coverage or partially out of coverage; wherein at least one of or all of the UEs comprising server UE, target UE and anchor UE communicating with each other using sidelink communications or PC5 communications; wherein at least one of or all of the UEs comprising server UE, target UE and one or more anchor UE are moving so that the position to be determined in the positioning session comprises a relative position of the target UE with respect to the one or more anchor UEs.

An embodiment provides a method for operating a server UE, especially UE acting as positioning session coordinator, comprising:
receiving positioning request (from its higher layers or from a second entity),
initiating and/or maintaining a positioning session for a target UE, wherein the positioning session comprises at least a measurement between the target UE and an anchor UE;
selecting out of a plurality of UEs at least one anchor UE fulfilling one or more anchor UE selection criteria; and/or
coordinating assignment of the configuration associated with at least one resource for transmission and/or for reception with the target UE and the anchor UE involved in the positioning session.

An embodiment provides a method for operating a target UE, especially UE acting as positioning session coordinator and target UE, comprising:
sending positioning request (from its higher layers or from a second entity),
creating and/or maintaining a positioning session for a target UE, wherein the positioning session comprises at least a measurement between the target UE and an anchor UE;
selecting out of a plurality of UEs at least one anchor UE fulfilling one or more anchor UE selection criteria;
coordinating assignment of at least one resource for transmission and/or for reception with the target UE and the anchor UE involved in the positioning session, wherein coordinating assignment comprises exchanging resource information on at least one resource to be used for transmitting and/or receiving a positioning reference signal;
participating in a positioning session.

An embodiment provides a method for operating a target UE comprising providing in response to a started positioning session information on one or more anchor UE selection criteria and to participate in a positioning session.

An embodiment provides a method for operating anchor UE comprising:
exchanging information with another UE so as to coordinate with the another UE acting as positioning session coordinator, wherein the information comprises one or more anchor UE selection criteria and/or at least one resource where the UE is able to transmit and/or receive positioning reference signals; and/or wherein the information comprises a configuration, wherein the configuration indicates at least one resource configured by the other UE where it is configured to transmit and/or receive sidelink positioning reference signals; and/or
transmitting and/or receiving a reference signal for the positioning session using the at least one configuration an information on which is exchanged; and/or
transmitting and/or receiving a reference signal so as to participate in a positioning session, wherein the anchor UE associates at least two messages associated with the positioning of the target UE to a positioning session maintained by the other UE.

The methods may be computer implemented.

### BRIEF DESCRIPTION OF THE DRAWINGS

Embodiments of the present invention will be explained below with reference to the accompanying drawings, in which:

FIG. 1 shows a schematic diagram illustrating depiction of UE positioning using sidelink reference signals according to embodiments;

FIG. 2 shows a schematic diagram illustrating centralized computation of a UE position, where the anchors and the target range with each other according to embodiments;

FIG. 3 shows a schematic diagram illustrating centralised computation of UE position, where the anchors may be moving and range among themselves too, according to embodiments;

FIG. 4 shows a schematic diagram illustrating semi-decentralised computation of UE position according to embodiments;

FIG. 5 shows a schematic diagram illustrating decentralized computation of UE position, according to embodiments;

FIG. 6 shows a schematic flowchart of sessionless operation where positioning is performed on a best effort basis according to embodiments;

FIG. 7 shows a schematic block diagram of preconfigured or configured assistance data provided to a UE, where an AD consists of multiple instances according to embodiments;

FIG. 8 shows a schematic block diagram of components of assistance data for sidelink positioning according to embodiments;

FIG. 9 shows a schematic flowchart of depiction of sidelink positioning where the UE searches for a UE hosting a positioning session according to embodiments;

FIGS. 10a/b show schematic block diagram and flowchart for illustrating Depiction of sidelink positioning where the UE creates a session and discovers at least one other anchor UE for positioning according to embodiments;

FIG. 11 shows a schematic diagram illustrating depiction of configuration of resources within a resource pool according to embodiments;

FIG. 12 shows a schematic block diagram illustrating an anchor participating in a session depending on UE location according to embodiments;

FIG. 13 shows a schematic flowchart illustrating the discovery of anchors in a session hosts the positioning session according to embodiments;

FIG. 14 shows a schematic flowchart illustrating the call flow where monitoring configuration is provided to enable maintaining the anchors and updating configuration according to embodiments;

FIG. 15 illustrates schematically the depiction of use of assistance data instances configured or pre-configured for a UE based on validity area according to embodiments;

FIG. 16 illustrates schematically depiction of group of UEs travelling together (the UEs may select the anchors based on the area where the UE are formed) according to embodiments;

FIG. 17 illustrates schematically the role of assistance UE to enable ranging between two UES that are not within communication range according to embodiments;

FIG. 18 illustrates schematically a flowchart for acquiring and/or reporting results of measurement where the session is managed at assistant UE; according to embodiments;

FIGS. 19a-d show schematic constellations of anchor UE and/or target UE and/or server UE according to embodiments; and

FIGS. 20a/b,21-23 show schematic block diagrams for illustrating aspect of communication systems used for embodiments.

### DETAILED DESCRIPTION OF THE INVENTION

Before discussing details, a description of terminology is given:
Target UE: UE to be positioned (in this context, using SL, i.e., PC5 interface).
Anchor UE: UE supporting positioning of target UE, e.g., by transmitting and/or receiving reference signals for positioning, providing positioning-related information, etc., over the SL interface.
Sidelink positioning: Positioning UE using reference signals transmitted over SL, i.e., PC5 interface, to obtain absolute position, relative position, or ranging information.
Ranging: Determination of the distance and/or the direction between a UE and another entity, e.g., anchor UE.
Sidelink positioning reference signal (SL PRS): Reference signal transmitted over SL for positioning purposes.
SL PRS (pre-) configuration: (Pre-)configured parameters of SL PRS such as time-frequency resources including its bandwidth and periodicity. This may also further include relatively static or predictable parameters of the UE—example of such parameters could be location of UE (e.g. for a fixed anchor) or anchor moving with constant velocity.
SLPP: Protocol for Sidelink positioning procedures. This protocol may be terminated between two UEs, or the protocol data unit may be encapsulated into other protocols such as LPP or RRC or NAS.
Location dependent parameters: absolute position, relative position, or ranging or angular information.

A session is an interaction between two or more UEs, wherein the UEs coordinate among themselves and/or are coordinated by an entity or more than one entities to deliver the location service pertaining to a target device requested by a location client. A location client may be the same as the target UE, a second UE, a network entity (e.g. NG-RAN node), a network function (e.g. LMF, NWDAF) or an entity internal or external to network sending a location request through GMLC or NEF or AMF. A location service may be a request for absolute position in local and/or global coordinates, range between the target UE and ranging counterpart, relative position, A session is time-limited and may be initiated and/or ended by a UE and/or a network entity. A session may be initiated as a result of location request by a location client, by sending the request to a target UE and/or a UE handling the location service and/or a network entity. A session may be formed by grouping together one or more location requests that have at least some characteristics in common. For example, a session may be formed by combining one or more location requests that have same QoS constraints and/or some common requirements (e.g. bandwidth). A server UE or a target UE acting as a server may may optionally jointly estimate position of one or more target UE using at least one anchor common that is coordinated by the same server node within a session.

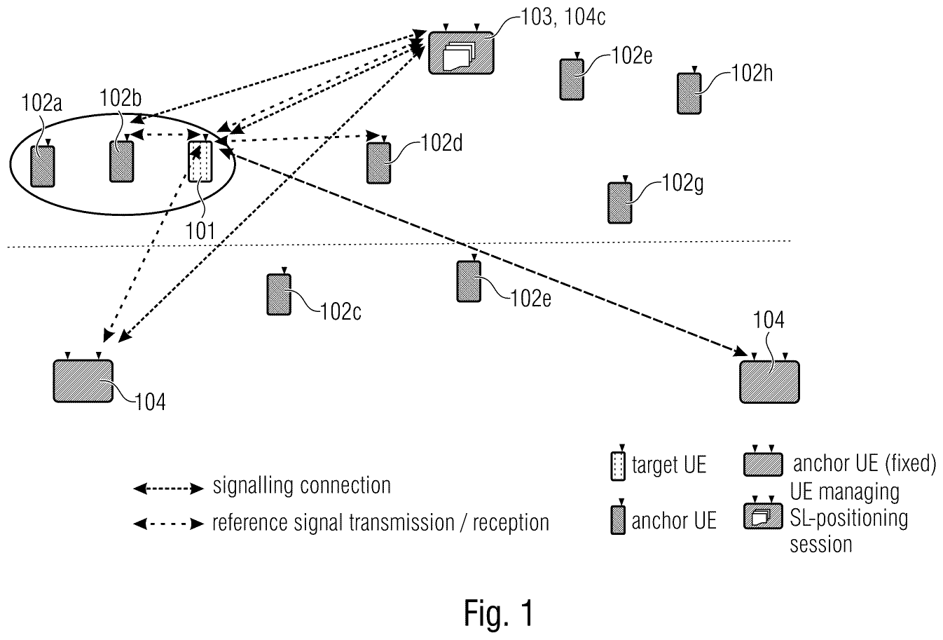

FIG. 1 depicts an example deployment of positioning using sidelink signals in an out-of-coverage scenario. The positioning scenario consists of a target UE 101, a UE whose location dependent parameter (e.g. range to a second UE, position in a local or global coordinate frame, velocity, speed, etc is to be determined). There is an UE 103 managing the sidelink positioning session. This may be a UE with server like functionality, where the UE may interact with one or more UEs 102a-102h to determine UE location-dependent parameters. Note, the target UE 101 may also take over the functionality of the positioning session coordinator 103, i.e. acting as positioning session coordinator. In the following, the term position or positioning or location services may also refer implicitly to any of the following absolute position, relative position or ranging or parameters, angle of arrival or angle or departure derived from it unless restricted explicitly. For using a positioning session, e.g. including positioning or ranging one or more anchor UEs 104a 104c, i.e. UE having fixed or known position, may be used. Not in the show scenario, the positioning session coordinator 103 is formed by an anchor UE 104c.

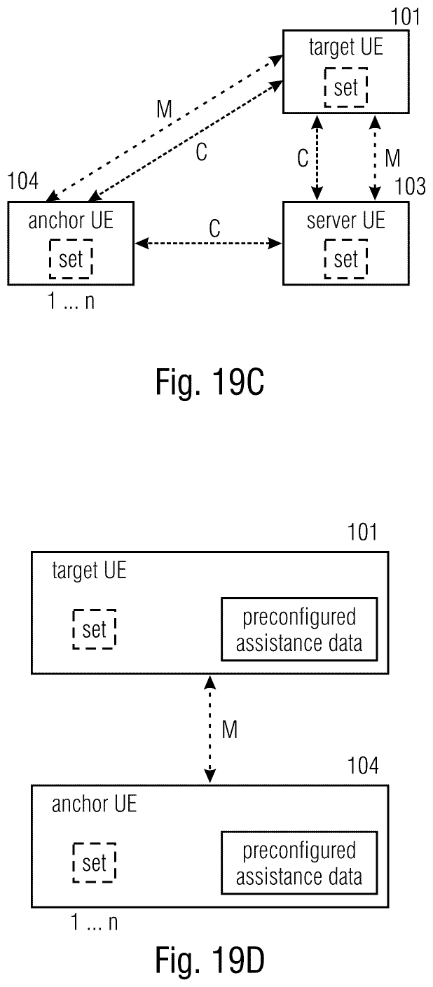

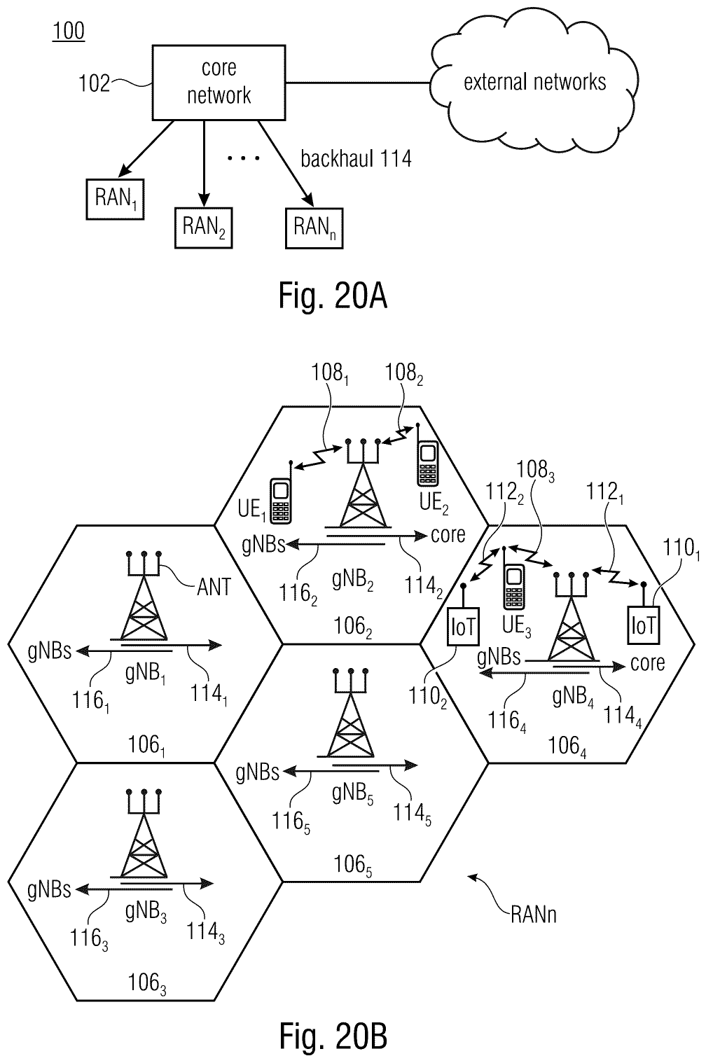

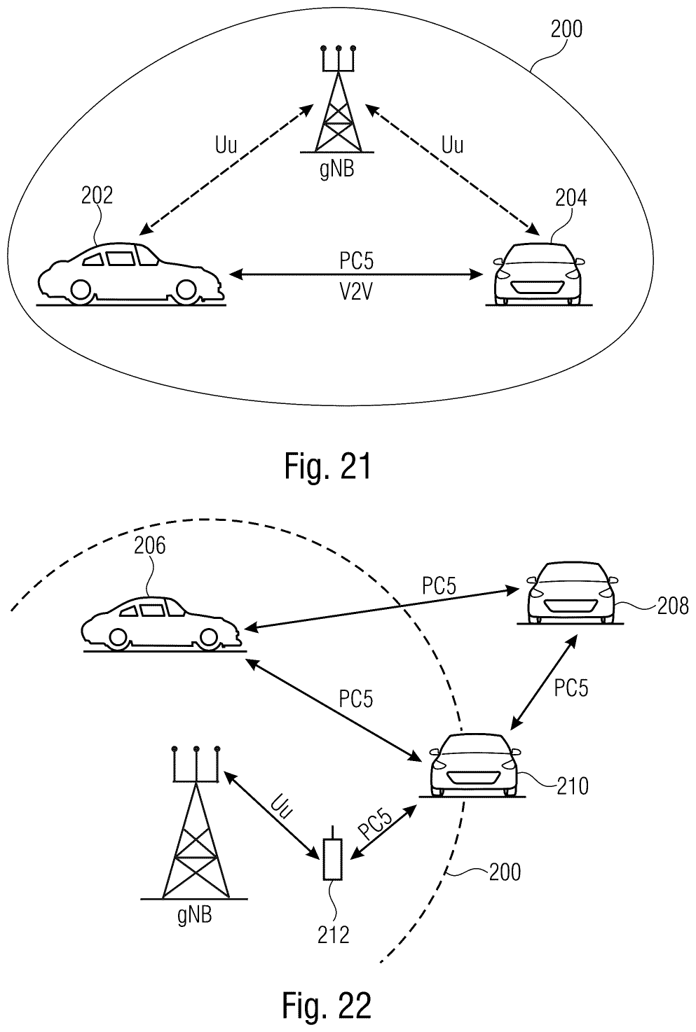

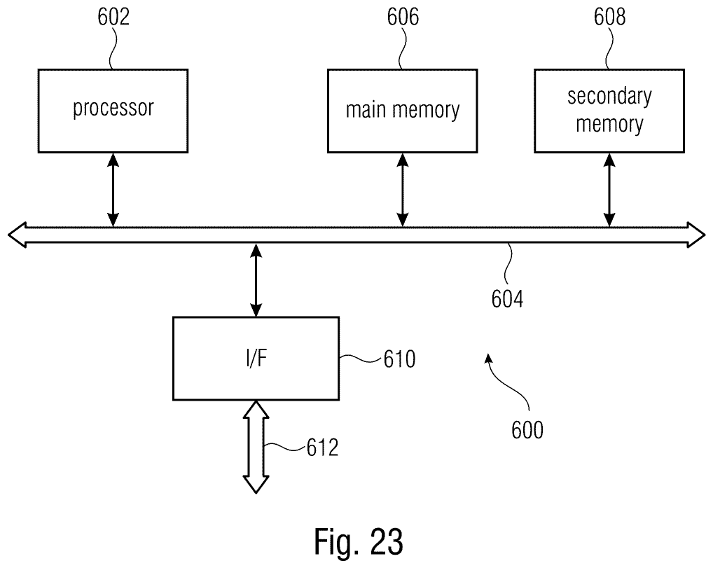

The procedure for managing the positioning session is shown in FIG. 19a-d.

FIG. 19a shows a target UE 101 communicating with an anchor UE 104 and a positioning session coordinator 103.

A location service client for sidelink positioning and/or hybrid sidelink and Uu-based positioning, e.g. requests a positioning service. A UE 103 which manages at least the sidelink positioning session (cf. arrow C) for a target UE 101 receives a positioning request from its higher layers or from a second entity, wherein the second entity may be a target UE 101, another UE in out of coverage, network entity or an UE in partial coverage, wherein the request includes at least a quality of service parameter, where the quality of service parameter may consist of one or more of the following: accuracy, latency, update rate, integrity (protection level, alert limit, time to alert).

In the scenario of FIG. 19 the server UE 103 provides the entailed configuration data and/or resources to the target UE 101 and 104. Between the anchor UE 104 and the target UE 103 a measurement is performed as illustrated by the arrow M. For example, the position of the anchor UE 104 is known. Additionally, a measurement between the target UE 101 and the server UE 103 may be performed as well. Here it would be of advantage that the server UE is a kind of anchor UE, i.e., UE, were the position is known.

As illustrated here, the UE 103 carries out the signaling connection C to the two UEs 104 and 101. For example, the server UE 103 may be a UE which has the capability and/or is authorized to act as a server UE. For target UE in coverage or partial coverage scenario, the server UE may be represented by a base station like UE, such as integrated access and backhaul (IAB) node. Here, it is assumed that the two UEs 101 and 104 are in coverage. The two UEs 101, 104 communicate with each other via sidelink. In the scenario of FIG. 19b, of the UEs, e.g., the anchor UE 104 or the target UE 101 takes over the functionality of the positioning session coordinator 103. This means that it receives the request and manages the sidelink positioning session as illustrated by the arrow C. Furthermore, the positioning session, i.e., the measure (cf. arrow M) is performed between the two UEs 101 and 104. In case a plurality of anchor UEs 104 are used, it would be of advantage that the managing functions are performed by the target UE 101.

The scenario of FIG. 19c is comparable to a scenario of FIG. 19a, wherein signaling connection C is established between the UEs 104 and 101. Via the connections C, information/parameters regarding the SL-POS signal, e.g., the resources are exchanged.

According to further embodiments, this information may be preconfigured or exchanged using assistance data as illustrated by FIG. 19d.

FIG. 19d shows a target UE 101 communicating with an anchor UE 104, where the two UEs exchange data, e.g., the reference signal (reference signal transmission/reception) so as to perform the measurement for the positioning or arranging.

Below, examples for the content of the signal connection C will be discussed.

A positioning session may be created at one entity and may be transferred to another entity. A session may be concurrently hosted at more than one entities, this may be
1) In preparation of session-handover between two entities acting as servers.
2) In preparation of session-splitting between two entities acting as servers.
3) In preparation of session-merging between two entities acting as servers.
4) For resilience
5) For providing information about other UEs already in the coverage of the server UE to a new server UE.

If there are multiple entities hosting a positioning session, one entity is responsible for computing and/or verifying the location service returned to the client. The other entity may be responsible for scheduling resources and/or computing a part of parameters used to deliver the final location service response.

The server node and/or a UE may be running an algorithm for estimating location service parameters (for example, a centralized and/or decentralized Kalman Filter), where the said algorithm may update at least one parameter comprising the state of the algorithm (e.g. Kalman Filter). The update may be based on at least one update in the parameter of the state of the (e.g. Kalman filter) and/or an update in measurement reported by at least one UE.

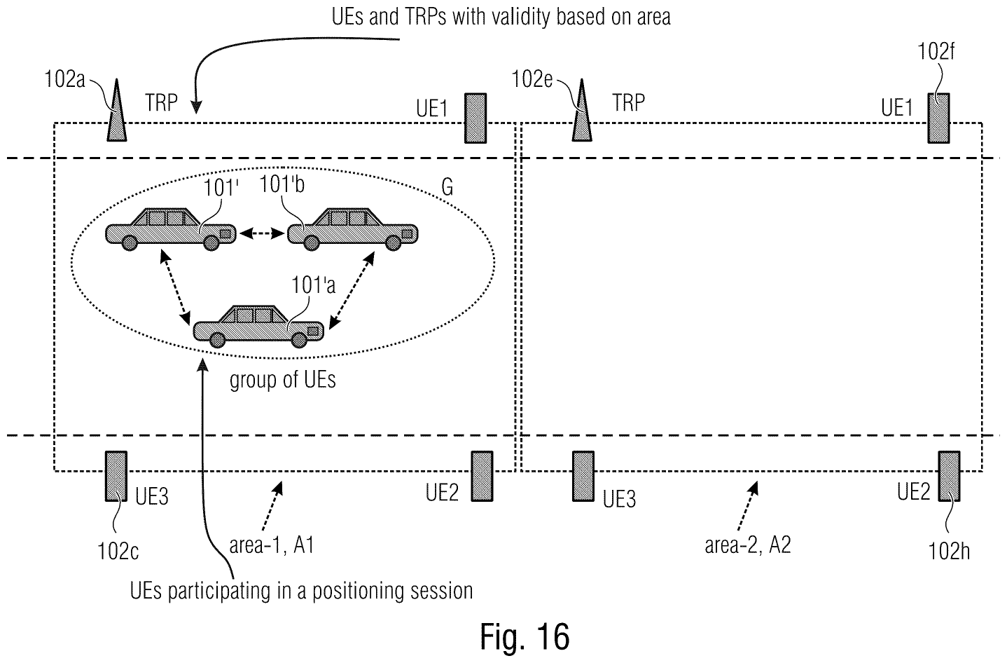

It is possible that multiple entities host and/or share a positioning session for the same UE in a decentralized manner. Said situation where multiple entities 101′, 101a′ and 101′b share a positioning session is illustrated by FIG. 16. In that case, at least one server UE (e.g. 101′) may estimate a new position using an updated information available to the server UE and/or estimation results from previous information and/or measurement available at the server UE and/or other server UE. The updated information (e.g. on the changed A1→A2) may be transmitted to other UEs and/or server node. The information may include the anchors 102a-102g highlighted within an area A1/A2 are indicated as a candidate list of anchor UEs 102a-102g for the target UE to discover. Likewise, there may be a server UE that obtains position and/or ranging information and/or measurement between target UE and anchor UEs in sidelink and the second entity may be the LMF that computes the final position of the target UE. For example, the LMF may provide information about the possible list of anchors in the vicinity of the target UE. The list of anchors may be provided as a list of anchors within an area.

The algorithm may be running in centralized and/or decentralized manner For example, as centralized and decentralized extended Kalman Filter. The algorithm may be internal to UE implementation. In a centralized approach, a centralized entity computes the position after collecting at least one range from the target to at least an anchor and/or range between two anchors. The computed information may be transmitted by the central entity (for example, the server UE) to one or more UEs and/or server nodes.

In a decentralized approach, at least two nodes estimate the position of at least two nodes in the network using measurements and information (e.g. state information from other nodes available).

The computed information may be shared between any two UEs using unicast and/or among a group of UEs using groupcast and/or among all UEs using broadcast. While groupcast and/or broadcast may improve the number of messages to be transmitted, this can lead to privacy issues, where a UE may not want to disclose the location information to all UEs that can receive the groupcast and/or broadcasted signalling messages. This can be achieved by encrypting part of the assistance data and/or UEs, so that only the UEs that have the respective keys can obtain this information.

A target UE may select the server UE from one or more server UEs available for the target UE to select, using certain parameters and/or information as selection criteria.

### General

### Provisioning and (Pre-)Configuration of the UE

A UE may have capability to perform at least one function regarding positioning using sidelink reference signals. A UE enabled to participate in sidelink positioning may be able to at least one of the following:
1) Transmit sidelink reference signals
2) Receive and process sidelink reference signals
3) Act as an anchor
4) Act as a server UE
5) Act as an assistant UE
6) Act as a ranging peer.

A UE may provide its capabilities to one or more UEs to perform a certain role for sidelink positioning pertaining to its capability. The UE may provide the information to another UE, either in response to a capability request, in response to a discovery request or unsolicited.

The transmission of capability may be unicast, broadcast or groupcast depending on whether the capability is meant for a UE, all UEs that can receive this message or a certain group of UEs. Thus, the information may be provided as one of the following:
in response to capability request, as unicast
in response to discovery request,
unsolicitated as unicast, broadcast or groupcast.

A UE may be configured or pre-configured to belong to a certain group, identified by an identifier. Likewise, a UE may be configured or pre-configured to receive certain information, wherein the one of a group of at least one UE is configured with a certain identifier to enable the UE to receive certain type of information. UE may be authorized to receive or provide at least one information as a result of being configured to be in a certain group. As an example, a UE may be enabled to receive a message addressed to a group when the message is associated with an identifier (e.g. a destination Layer-2 ID). Likewise, a UE may provide certain information only to a restricted set of UEs, for example, its position to a sub-set of UEs authorized to this information. For example, an anchor UE may allow a server UE to receive its position but may not provide its position to a target UE which is acting as a direct peer.

A UE may be configured or pre-configured to act as a server UE for a given session. Within the session, the UE may act as an anchor or a target. The same UE may have a different role in a different positioning session.

One particular way to enable a UE to monitor certain type of information is to configure a UE to monitor resources in a receive resource pool configured for a UE configured with a certain Layer-2 Destination ID. The Layer-2 Destination ID may be based on
1) Type of service
2) Area
3) UE-identifier
4) Session ID
5) Group ID ( . . . etc)
6) Function
7) UE-role

The configuration or pre-configuration may enable the lower layers of the protocol stack to detect certain PSSCH transport blocks and forward to appropriate higher layer protocol for further processing.

### Location Request

A UE may be triggered to perform range measurement to another UE, either by its own higher layers or by a second entity. The second entity may be any one of the following:
1) Network entity, such as LMF or NG-RAN node or application function residing in core network
2) Another UE without sidelink transmission/reception capabilities
3) Another UE without sidelink transmission/reception capabilities at least for positioning reference signals
4) Another UE with sidelink

Note, during a positioning session one or more parameters, like an absolute position, relative position, range, . . . etc. may be determined. The parameters to be determined may be set by the location request, which could include absolute position, relative position, angle, range, . . . etc. Further it should be noted, that if a feature is described in context of one parameter, this feature may also be used for other parameter. Consequently, for the discussion of the features the terms position, range, location service, location dependent parameter, location dependent measurements are interchangeable. Of course, other parameters may be determined using the describe principles.

A location request for a UE in sidelink may include request for absolute position, relative position, range, velocity, orientation, etc.

The location request may further contain required characteristics of positioning—which may accuracy, integrity (characterized by at least one of the following—protection limit, alert limit, time to alert, target integrity risk), update rate, latency, etc.

The integrity of a positioning system may be described by one or more of the following parameters:
Accuracy—which addresses how often the computed position deviates from the true position of the UE. This may be computed based on covariance of the position estimate made by the server UE and/or the target UE.
Update rate—which describes how often the position computed may be updated, for example, because of new measurements made by a target UE and/or the anchor UE.
Latency—which describes after what delay the position of the UE is available at the location client and/or at the server UE.
Availablity—which describes how often the system may be able to compute location dependent parameters of a UE

Target Integrity Risk (TIR). The TIR describes the probability that the positioning error exceeds the Alert Limit (AL) without warning the user within the required Time-to-Alert (TTA). The TIR is usually defined as a probability rate per unit time.

Alert Limit (AL). The AL describes the maximum allowable positioning error such that the positioning system is available for the intended application. If the positioning error is beyond the AL, operations are hazardous and ideally the positioning system should be declared unavailable for the intended application to prevent loss of integrity. The alert limit may be a 3D-alert limit or may be described by alert limit on horizontal plane and/or on the vertical axis. This may be called horizontal alert limit (HAL) or vertical alert limit (VAL) respectively.

Time-to-Alert (TTA). The TTA describes the maximum allowable elapsed time from when the positioning error exceeds the Alert Limit (AL) until the function providing position integrity annunciates a corresponding alert.

Protection Level (PL). The PL is a statistical upper-bound of the positioning error that ensures that, the probability per unit of time of the true error being greater than the AL and the PL being less than or equal to the AL, for longer than the TTA, is less than the required TIR. Similar to alert limit, the protection level may be specified for a 3D or for one or more of the components (e.g., horizontal protection limit and/or vertical protection limit).

The parameters target integrity risk (TIR), alert limit (AL), time to alert (TTA) may map to one of the positioning service levels, depending on the integrity assurance needed by the system. The quality and confidence of the measurement (e.g., the protection level) computed either by the UE and/or by the network entity and/or by the server UE and may be used to determine whether the system is available or not.

### Sidelink Ranging and Positioning

In a simple sessionless operation, where position may be obtained by performing ranging between UEs, where one UE may discover another UE, obtain and/or provide configuration of reference signals, transmit and/or receive reference signals, optionally exchange measurements and compute the desired location service (position, range, etc). The configuration of the reference signals may be exchanged between the UEs, or they may be configured by the network. The network may provide UEs with certain information to enable the UEs to range with each other in sidelink or hybrid scenarios involving sidelink and Uu. The information is called assistance data. The positioning may be performed in a sessionless manner using such assistance data, where monitoring that the quality of service is met. The sessionless operation may be a standalone operation, where location service is obtained in a best effort basis or the sessionless operation may be the first step towards creating and managing session in a session-based approach, where the UEs are selected and managed by one or more UEs acting as session coordinators to ensure a quality of service.

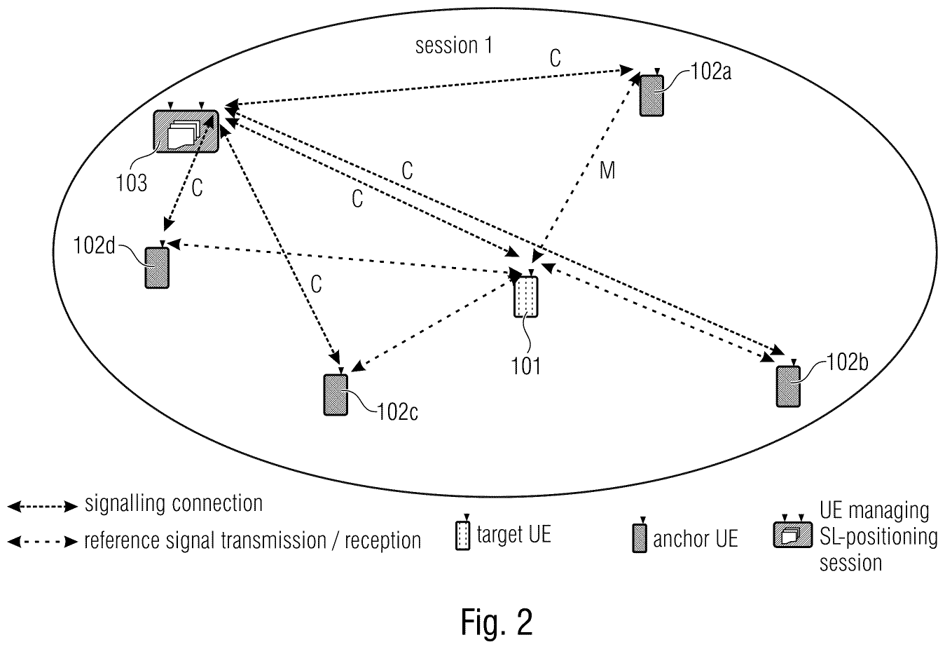

With respect to FIGS. 2, 3, 4 and 5 different approaches for the positioning and arranging will be discussed. In all figures the target UE is marked by the reference numeral 101, wherein the positioning session coordinator is marked by the reference numeral 103. The one or more used anchor UEs are marked by the reference numerals 102a to 102d. Again, the signals exchanged for arranging/positioning, i.e., the reference signal or sidelink reference signal are marked by the reference numeral M, wherein the communication used for signaling connection are marked by the reference numeral C.

FIG. 2 shows a centralized computation of the UE position, where the anchor small hardware 102a to 102d and the target 101 range each other. As shown, the positioning session coordinator 103 has a signaling connection to all UEs involved, i.e., to 101, 102a, 102b, 102c and 102d.

For example, via the signal connection, the measurement results can be reported to 103 which can perform the calculation.

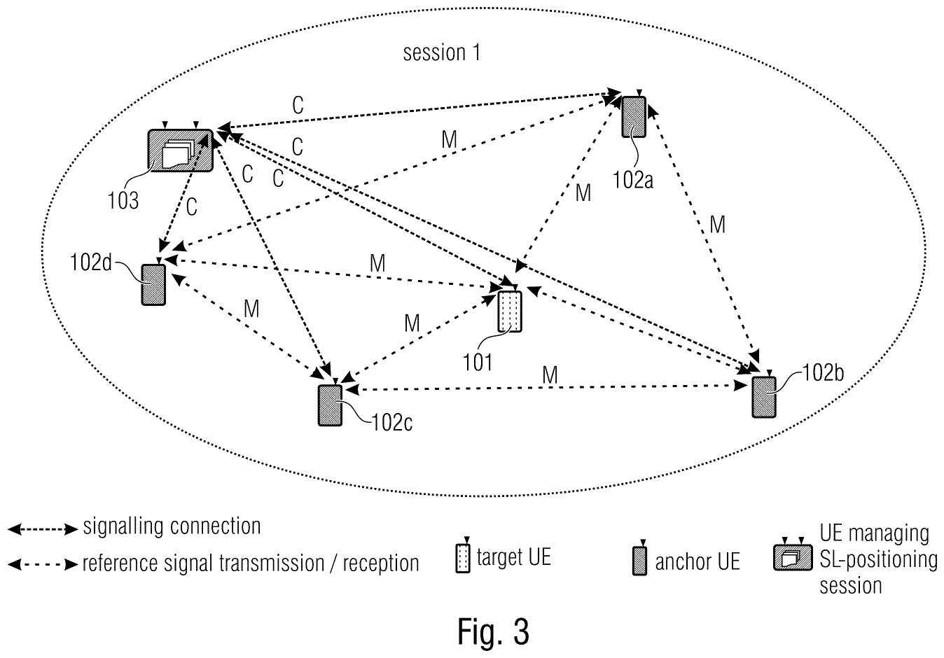

FIG. 3 shows a centralized computation of the UE position, where the anchors 102a to 102d perform the positioning/arranging to the target UE 101. Here, the assumption is made that the anchor UEs 102a to 102d are moving. Therefore, the anchor UEs 102a to 102d perform ranging among themselves. As illustrated by the additional arrows M.

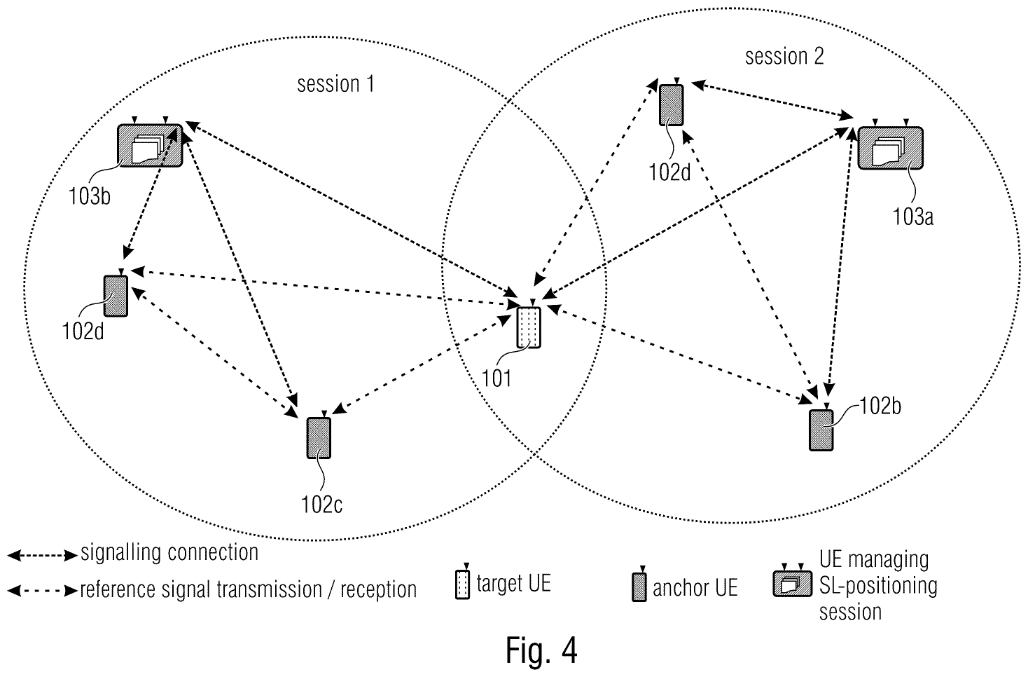

In respect to FIG. 4, a so called semi-centralized computation of the UE position is shown. In all above discussed scenarios of FIGS. 2 and 3 the assumption was made, that one positioning session coordinator 103 can reach all target and anchor UEs 101, 102a, 102b, 102c and 102d. According to the scenario of FIG. 4, two positioning session coordinators 103a and 103b are used for session one and session two. The target UE 101 is arranged so as to communication with the positioning session coordinator 103a of session one and 103b for session two. In each session two, anchor UEs 102a and 102b for session two and 102c and 102d for session one are available.

As discussed above, the positioning session coordinator 103a and 103b, respectively, has a signaling connection C to the respective UEs of the respective session so as to manage the positioning session. Starting from this, the three UEs 102d, 102c and 101 in session two and 102a and 102b and 101 in session one perform a corresponding measurement among each other.

Background is that each server 103a and 103b only has a portion of ranges it can obtain. It may need to exchange information between two servers 103a and 103b to allow the computation. A server 103a and 103b may not have direct signaling connection to each anchor UE. There may also be ranging between the anchor and/or the position and covariance of the position may be exchanged.

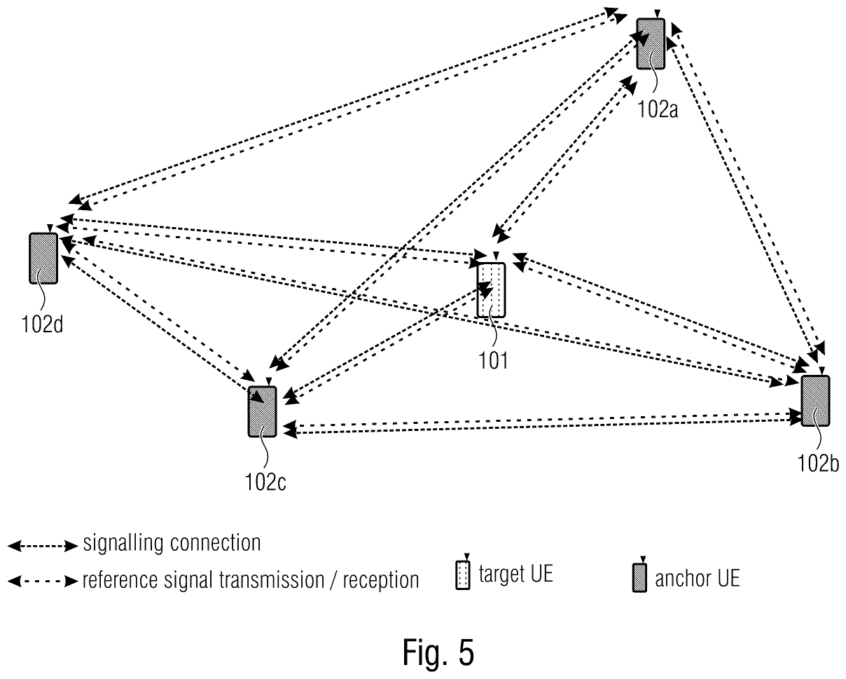

FIG. 5 shows a scenario for decentralized computation of the UE position. Here the four anchor UEs 102a to 102d are present, wherein the target UE 101 communicates with all anchor UEs 102a to 102d. Comparable to the embodiments above, the signaling connection and/or the reference signal transmission and/or reception is exchanged using sidelink communication. However, here no fixed UE which is according to the above embodiments formed by 103a and 103b is available. Thus, just a relative positioning in a swarm is performed. Each UE runs an algorithm to estimate precision based on measurements and estimates (e.g., of states such as precision, velocity) and/or their covariances.

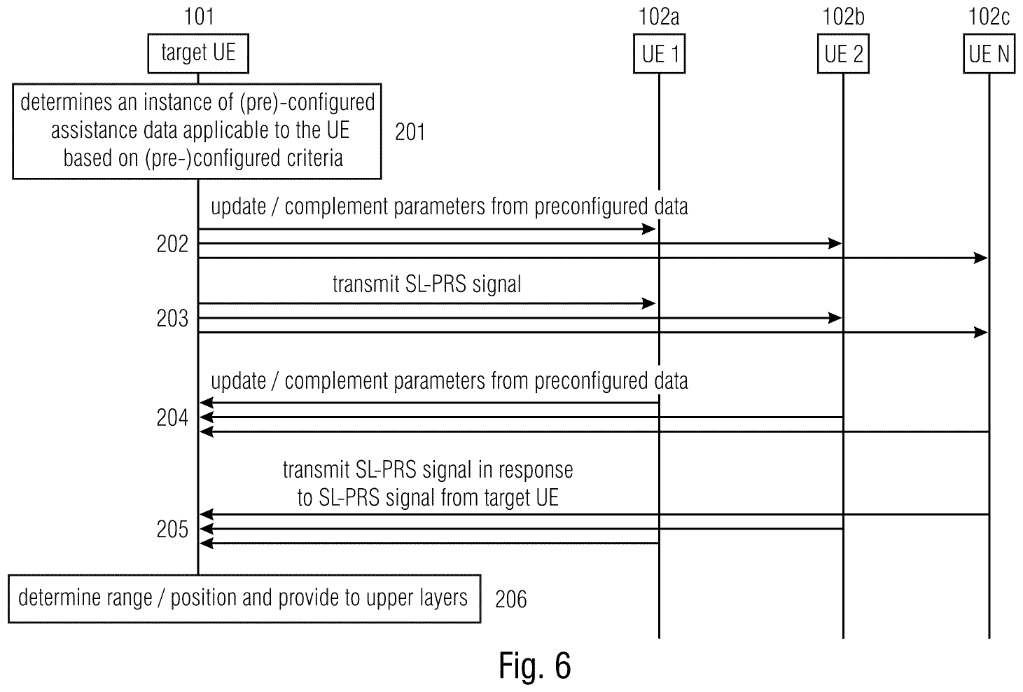

An example of sessionless operation where positioning is performed on best effort basis is illustrated in FIG. 6. FIG. 6 shows the communication between the target UE 101 and further UEs 102a, 102b and 102c. In the first step 201, an instance of (pre-)configured assistance data applicable to the UE 102a, 102b, 102c based on (pre-)configured criteria may be determined by the target UE 101. After that, in the steps 202, 203, 204 and 205, complement parameters from preconfigured data are provided/updated (cf. step 202 and 204 perform for different directions), the SL-PRS signal is transmitted (cf. 203 and 205 perform for different directions). Starting from this, the computation engine, here the target UE 101, can determine the range/position and provide the upper layers (cf. step 206).

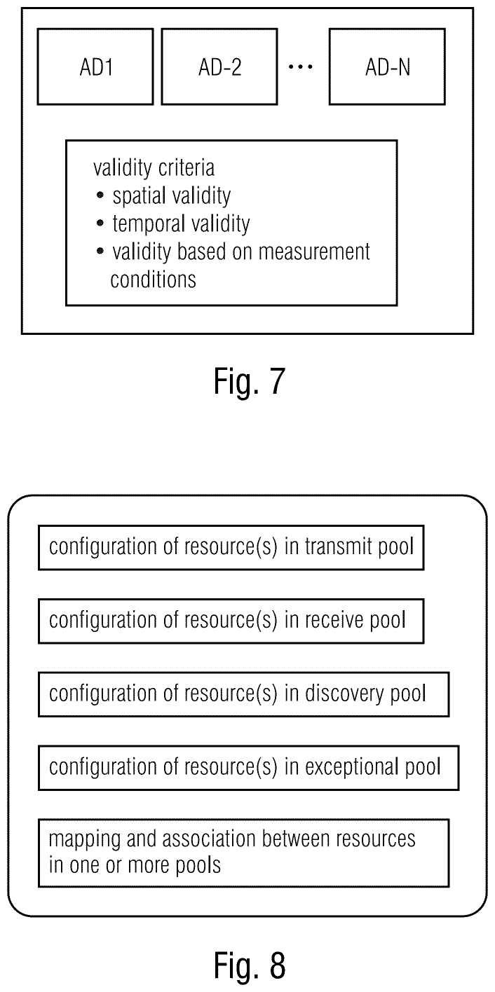

As discussed above, so-called configured or preconfigured assistance data are provided. Components of preconfigured or configured assistance data provided to a UE where an AD may consist of one or more instances are illustrated in FIG. 7.

### Assistance Data

The assistance data provided to the UE may have one or more instances. In case the UE is configured with multiple instances, then the UE shall be provided with information on how to select the assistance data for positioning at a given time. The assistance data instance can be provided a spatial validity, which indicates an area where the assistance data is valid. Likewise, the assistance data may be valid for a certain time interval. Furthermore, the assistance data may be valid only if certain conditions are fulfilled (for example: RSRP on a certain reference signal is above a certain threshold). The validity conditions may be combined in any logical manner, i.e. the assistance data may be applicable when at least one condition is valid (OR condition) or it may be applicable when all conditions are valid (AND condition) or any combinations thereof.

A UE may check if the assistance data it has been configured with is valid for use. If the assistance data is valid, then the data may be used by the UE, for example, for transmitting a signal, receiving a signal or computing position or selecting a UE with a certain role. If the assistance data is not configured with validity criterion, then the UE may assume that it is valid when the assistance data is received. A new assistance data may replace the existing assistance data or the assistance data may be invalid when it is so indicated.

An assistance data or an assistance data parameter could contain at least one of the following parameters:
1) Location (e.g. x,y,z coordinates) of an anchor UE; for example, the parameter may be set as follows: AnchorUELocationInformation in the CommomSL-PRS-MethodsIDsProvideAssistanceData
2) Uncertainty in the location provided, for example, covariance from estimation step, error bounds or any other parameter that reflect the quality of location estimate or integrity parameters (such as alert limit, protection limit, time to alert, target integrity risk).
3) Information indicating the mobility status of anchor UE (e.g. instantaneous velocity or if the anchor UE is a fixed UE (e.g. roadside unit)).
4) Information about positioning server UE and/or an assistant UE, for example an identifier such as Layer 2 Destination ID of the server UE, IP address, a higher layer identifier with which the positioning server UE can be addressed etc.
5) Configuration of reference signals that the UE transmits to an anchor UE and/or receive from an anchor UE; Configuration of reference signals may be SI-PRS-AssistanceData

In line with the procedure, a UE may be configured with at least one resource in transmit pool, wherein the UE may be configured with one or more parameters indicating
1) Time and frequency allocation of resource elements carrying the reference signals
2) The sequence ID to be used for generating the transmitted sequence or parameters that can be used to compute the sequence ID (for example, if the sequence ID is based on a user ID).
3) Parameters for power control
4) Parameters for beamforming

In line with the procedure, a UE may be configured with at least one resource in receive pool, wherein the UE may be configured with one or more parameters indicating
1) Time and frequency allocation of resource elements carrying the reference signals
2) The sequence ID to be used for generating the transmitted sequence or parameters that can be used to compute the sequence ID (for example, if the sequence ID is based on a user ID).
3) Parameters for beamforming

In line with the procedure, a UE may be configured with at least one resource in a discovery pool, wherein the UE may be configured with one or more parameters indicating
1) Time and frequency allocation of resource elements carrying the reference signals
2) The sequence ID to be used for generating the transmitted sequence or parameters that can be used to compute the sequence ID (for example, if the sequence ID is based on a user ID).
3) Parameters for beamforming

In line with the procedure, a UE may be configured with at least one resource in an exceptional pool, wherein the UE may be configured with one or more parameters indicating
1) Time and frequency allocation of resource elements carrying the reference signals
2) The sequence ID to be used for generating the transmitted sequence or parameters that can be used to compute the sequence ID (for example, if the sequence ID is based on a user ID).
3) Parameters for power control
4) Parameters for beamforming

There may be an association between two resources in a pool and/or among two resources or more resources in two or more pools.

For example, when a UE has transmitted a reference signal in a discovery pool, it may attempt to receive a reference signal in one of the receive pools.

Second example, a resource in a transmit pool configured for a UE may be associated with a resource in receive pool configured for the UE. When a UE receives a reference signal in its receive pool, then the UE may transmit a reference signal in one of the transmit pool if certain conditions are met. The responding UE may also adapt certain signal characteristics depending on measurement of the signal received in its receive pool.

In line with the second example, an anchor UE may configured with a receive resource configuration in a receive pool. A target UE may be configured with a corresponding resource configuration and transmit a reference signal, so that it will be received by the anchor UE. The receive resource for the anchor UE is associated with second resource on a transmit pool for the anchor UE. If the signal received by the anchor UE fulfils certain condition, then the anchor UE may respond back to the target UE by transmitting a reference signal on the resource on the transmit pool which is associated with the resource on the receive pool of the anchor UE. Optionally, the signal transmitted by the anchor UE may be adjusted (for example, by adjusting the transmit time, or adjusting cyclic shift). The target UE then listens to its receive pool (which corresponds to the transmit resource on transmit pool of the anchor UE) and measures one of the parameters (for example: round trip time). This is illustrated by FIG. 8.

FIG. 8 shows exemplarily components of assistance data for sidelink positioning. One or more of the parameters may be present.

### Server UE Discovery and Selection

The selection criteria may be based on the QoS requested by the location service client and/or by the positioning method requested. The selection criteria may be defined by a combination of one or more parameters and/or information, which the target UE may acquire about the server UE by various means. A target UE may acquire the information about one or more server UEs by any one of the following means:
1) Receiving and/or decoding the broadcast and/or groupcast messages sent by the target UE
2) Receiving response from one or more server UEs in response to discovery message sent by the target UE
3) Using assistance data provided by the network via another UE in coverage, wherein the assistance data may indicate the availability of a server UE in a certain validity area.
4) By exchanging keys while establishing security—during ciphering and integrity protection.

The server UE may provide the target UE the following information as a part of discovery procedure. The server UE may announce its capabilities via broadcast and/or groupcast and/or unicast to the target UE. The server UE may provide the information either as unsolicited transmission to the target UE or in response to capability request by a target UE or a system information request by the target UE. Likewise, the server UE may also provide status report in a similar manner. Alternatively, the status report could be transmitted as capabilities of a UE which may vary.

The selection criteria for the server UE selection provided via unicast, groupcast or broadcast messages may include one or more of the following: Capability for the UE to act as a server
1) The UE acting as a server UE or a positioning session manager may be pre-configured and/or configured by the network to have capabilities to act as a server. The server may indicate its server capabilities to the target UE by indicating the server as one of the roles supported by the UE.
2) Location (absolute or relative) of the server UE

The target UE may be able to select the server UE with respect to its own location, which may have been obtained using alternate sources (e.g. GNSS)
3) Mobility state of the target UE and/or server UE

The target UE and the server UE may be part of a group of UEs moving together. The group of UEs moving together may be configured by the application layer.
4) Group Membership of the target UE and/or the server UE

The target may advantageously or exclusively select a server UE belonging to the same group as itself. The group could be associated to the same serving PLMN, same type of service as indicated by application layer, same OEM, to name a few examples. According to embodiments, the group membership may be used as selection criterion for selecting an anchor UE and/or coordinating UE.
5) Synchronization reference of the server UE (SyncRef UE)

For example, a target UE may advantageously choose a server UE with a higher quality synchronization reference. For example, if a UE is synchronized with its own internal clock, it may use the UE which is indirectly synchronized by a network node as a server UE over a UE which is using indirect synchronization.
6) Energy considerations at the server UE (e.g. power saving profiles, battery status)

For example, a target UE may advantageously choose a server UE with lower current load or higher remaining battery power status over the UE having lower remaining battery power status, or a UE having a higher ON cycle in its DRX duty cycle.
7) Coverage and/or connectivity state of the server UE

For example, a target UE may advantageously select a server UE in partial coverage over a server UE in out-of-coverage. The measurements may then be routed via the server UE to the network entity (e.g. LMF) which computes the final position of the target UE.
8) Number of anchors currently managed by the UE

The target UE may select a server UE depending on the number of anchors it has already established connections with. The anchors may be part of session for target UE. The higher number of anchors may reduce the discovery procedure for the target UE.
9) DOP value for a given location

The server UE may be able to provide sample DOP values at one or more reference positions within the coverage region of the server UE. This may indicate to the target UE whether the announced DOP values may suffice for its QoS requirements.
10) Latency values on signalling link

The server UE may be able to provide sample latency values at one or more signalling links with one or more anchors within the coverage region of the server UE. This may indicate to the target UE whether the announced latency values may suffice for its QoS requirements.
11) QoS classes pertaining to positioning supported by the server UE

The server UE may announce identifiers indicating the QoS the server UE can support. The identifiers may relate to a KPI or different combinations of one or more KPI-for example, accuracy and latency (e.g. 1 m accuracy with a latency 10 cm). The target UE may choose the server UE that best fits the QoS classes.
12) Support of session handover by the server UE

For example, the server UE may be overloaded but it may be announcing a larger number of anchors and a good DOP. The target UE may be able to select this server UE and ask the server UE to handover the session to itself or another server UE. This reduces the discovery and setup time for the anchors. A target UE may take the capability to handover the session as one of the parameters.

Some of the selection criteria for server UE selection may be available to the target UE as a part of establishing security (ciphering and/or integrity protection) between the server and the target UE.
1) Authorization of the UE to act as a server UE for a given target UE
2) Authorization for the target UE to select a certain server UE as its positioning server.

The server and/or the target UE may restrict the use of the target UE or sever UEs to a group of UEs that are authorized to perform this role for the UEs.

The UEs may be configured or preconfigured with certain keys with which they are able to authenticate with each/other. In response to a discovery message and/or a signalling message to create a session, the server UE may initiate a security establishment procedure. If the target UE successfully authenticates with the server UE, thereby establishing at least integrity protection and/or ciphering, then the server UE may create a session for the target UE.

Alternatively, the target UE may attempt to initiate the security establishment procedure to ensure that the target UE is allowed to use server UE and/or vice versa.

On failure to create a session with the selected server UE, the target UE may initiate an attempt with another server.

Some of the selection criteria for the server UE selection may be available to the target UE only after establishing security and/or ensuring that the target UE is authorized to receive this information. In a variant, there may be at least one of the parameters in the broadcast could be ciphered and may be deciphered only if the target has the security keys. Alternatively, at least one parameter is provided by the server UE after establishing security and/or authentication. In general, any of the parameters applicable to server UE selection could be provided only after security is enabled. However, there certain parameters may only be transferred after security is applied.

The example of parameters that may be provided by server UE after establishing could include
1) Location (absolute or relative) of the server UE
2) Mobility state of the server UE
3) Group Membership of the target UE and/or the server UE
4) Signalling latency between the target UE and the server UE
5) Signalling latency between the anchor UEs and the server UE

A target UE may acquire one or more of the parameters it needs for selection by:
1) Initiating a discovery procedure, requesting response from UEs supporting certain functionalities and/or requesting indication of additional parameters.
2) Acquiring a system information (from Uu or sidelink) and/or receiving broadcasted information from the server UE.
3) Performing measurements on one or more reference signals.

The UE may initiate a connection with a server UE fulfilling a selection criteria. The combination of the selection criteria which the UE uses may be implementation dependent and may utilize at least one information about the server UE that the target UE has acquired. Alternatively, the selection criteria may be configured or pre-configured to the UE.

The UE may be configured by the network to acquire certain parameters pertaining to the server UE. In one variant, the UE may exclude a server UE if certain conditions are fulfilled or not. For example, whether both the server UE and the target UE are served by the same PLMN. In other example, the UE may be configured to use one or more criteria to determine the suitable server UE. The UE may additionally be configured to apply different weights to different criteria and select the server UE based on the results. For example, the number obtained by evaluating different criteria is above a certain threshold value.

The parameters that form a part of the selection criteria for a UE may be QoS dependent. For example, if a QoS condition entails 1 m accuracy and 10 ms accuracy, the server UEs have latency above 5 ms (for example) may be excluded. At the same time, if the same target UE needs a location service 1 cm accuracy, then the latency may not be a criteria but DOP may be a criteria.

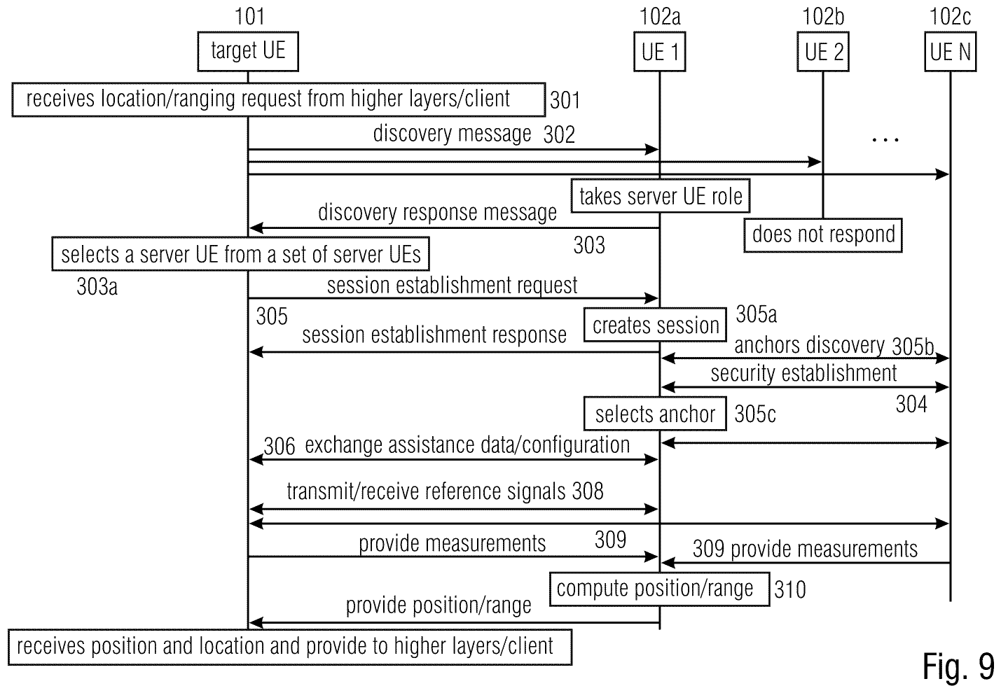

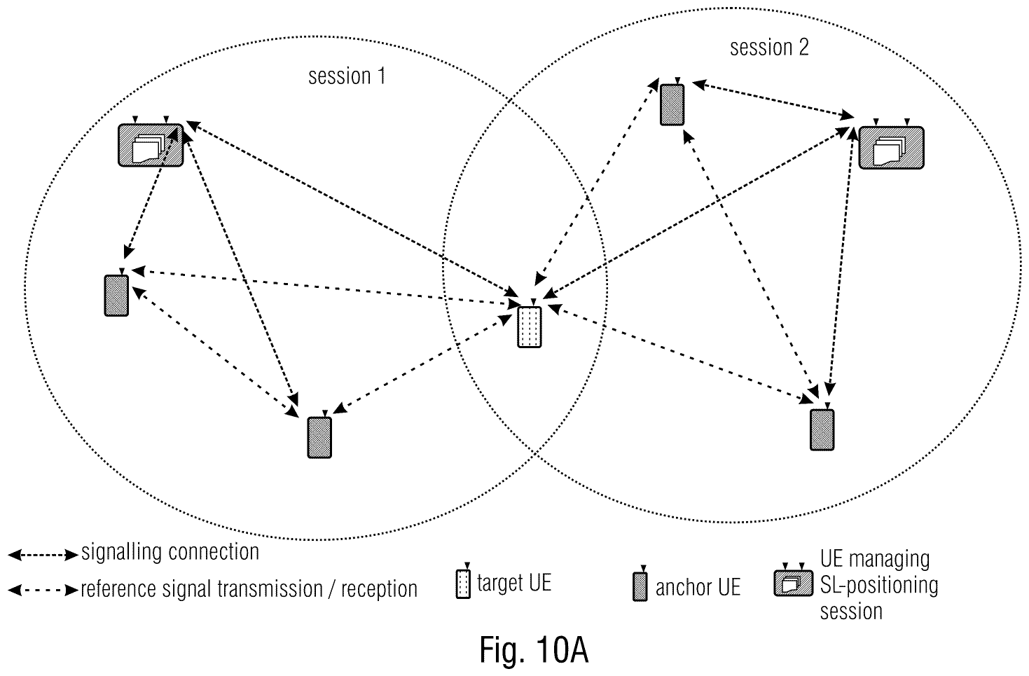

With respect to FIG. 9, a depiction of sidelink positioning where the UE searches for a UE hosting a positioning session is illustrated. FIG. 9 shows a flow chart where the target UE 101 receives in step 301 a location/ranging request from a higher layer/client.

The target UE 101 initiates a server discovery procedure by sending a discovery message 252, where the discovery message indicates that it is seeking a UE with a positioning service functionality. It may further indicate one or more parameters, which form its selection criteria. The UEs that fulfill its selection criteria for a server respond to the target UE.

The UE 102a takes over server UE. This means that it is depicted that the target UE 101 has selected UE1 as a server UE and the UE 1 begins the process of discovering anchors and adding to the session. It is also possible that the anchor discovery 303 and/or security establishment 304 with anchors may have already taken place before the location request from the target UE. The UE in this case, simply indicates the positioning session corresponding to the target UE to the anchors UEs by associating the messages together, for example, using an identifier (e.g. session identifier).

For the session creation, i.e., after the server UE is selected from a set of server UEs (cf. step 303a) and by use of the session establishment request and session establishment response 305. The session created is marked by 305a.

According to embodiments, a positioning session between two UEs is established when the first UE sends an SLPP message and the second UE responds back to the received SLPP message. All further messages exchanged between the UEs are identified by including the session identifier within the SLPP message exchanged. The session establishment request may be the first SLPP message sent out and the session establishment response may be the response to the SLPP message.

In response to this, an anchor, here the UE 102c, may be discovered (cf. step 305b) and then selected (cf. 305c).

After the selection 305c, optional steps for exchanging assistance data/configuration 306 may follow between 101 and 102a and 102a and 102b since 102a acts as positioning session coordinator. This step is illustrated by the reference numeral 306 and typically performed before the positioning session steps 308 and 309 are performed. During the step 308, the reference signals are transmitted and received, i.e., exchanged between the UEs 101 and 102a. Furthermore, the measurements are provided to the positioning session coordinator 102a during the step 309. Based on the measurements, the positioning session coordinator can compute the position/range in the step 310. Optionally, the UE 102a provides the session and/or range to other UEs, like the target UE 102 which receives the position and location and can provide it to higher layers/clients.

According to further embodiments, the target UE 101 is selected as server UE in the step 303a so that the position and/or range must not be forwarded but can be directly transmitted to a higher layer/client or used by the target UE 101 itself.

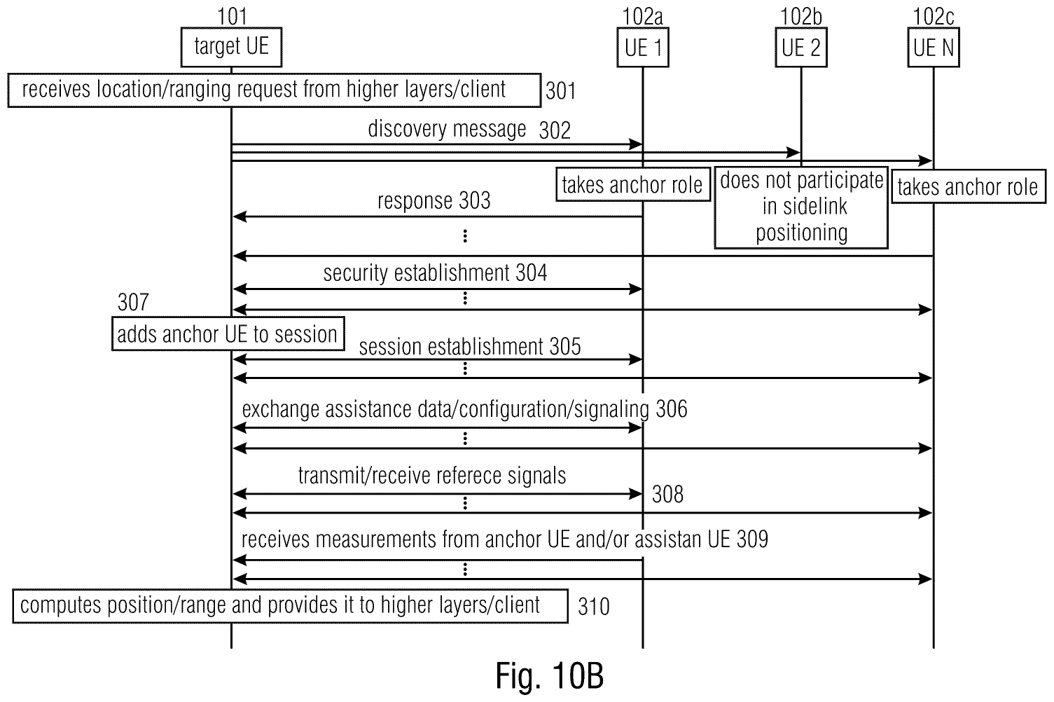

Alternatively, a target UE under certain circumstances (for example, discovering more than one server nodes, but each controlling an insufficient number of anchors (UEs or TRPs) establish a session each with more than one server. It may then request merging and/or handover of sessions, where one server UE manages the session originally managed by two UEs. The target UE may also acquire the measurement from both servers and combine the measurement provided by the at least two servers to obtain position. In one version, both servers may be UEs capable of sidelink positioning server functionality. In other version, the second server may be a LMF and at least one of the nodes measuring a positioning reference signal from a UE and/or transmitting a positioning reference signal to the UE may be a network node (e.g. a TRP). The measurements from the first server may be combined and the second server at the UE or at the LMF to obtain the UE position. At least one UE and/or the sidelink server may be in coverage or in partial coverage in this example (cf. FIG. 10a). This scenario as illustrated by FIG. 10 is comparable to the scenario as already discussed in the context of FIG. 4.

The LMF may according to embodiments be pre-configured with the list of candidate Located UEs including e.g. the capability, stationary information and location information of the Located UE(s), e.g. RSU or the operator deployed Located UE. The LMF may provide to the Target UE a list of candidate Located UE(s).

The discovery of Located UEs follows the same principles as specified above. The UE can indicate its role “Located UE” in its list of supported roles during discovery, if it is authorized to be a Located UE in a given PLMN as per the Authorization and Provisioning for Ranging/SL positioning service as specified above. For example, the Target UE may discover and select one or more Located UEs to be used in the Ranging/SL positioning procedures as specified.

Multiple candidate Located UEs may be discovered, in that case, the Located UE(s) is selected from the candidate Located UE list. The Located UE(s) is selected based on:
Candidate list of Located UE(s), if available.
Capabilities of the candidate Located UE(s), e.g. the supported Sidelink Positioning methods.
The required positioning QoS.
Whether the serving PLMN of candidate Located UE(s) is same with serving PLMN of Target UE.
UE's information including whether UE is in coverage or not, UE's location, etc.

For example, when LMF determines SL positioning for target UE and trigger the discovery of the Located UE, LMF can decide that LMF or target UE selects Located UEs. If the decision is LMF selecting Located UEs, Target UE sends the multiple discovered candidate Located UEs to the LMF for the selection. After the LMF determines the selected Located UE(s), the LMF sends the selected Located UE(s) to the Target UE.

LMF could provide located UE for discovery when AF request ranging between two UEs. Additionally, LMF may be provisioned with Located UEs that may be sent to target UE as candidate list of located UEs.

If a target UE does not find a second UE that is able to manage a session for the target UE, then the target UE may create the session by itself. It may then initiate the process of selection of anchors.

Alternatively, the target UE may be enabled by the network or by preconfiguration to initiate positioning method as a positioning server.

With respect to FIG. 10b, the steps for the depiction of a sidelink positioning where the UE creates a session and discovers at least one other anchor UE for positioning will be discussed. FIG. 10b depicts an example where the target UE creates a session itself and manages the positioning session. A session between two UEs is established when the first UE sends an SLPP message and the second UE responds back to the received SLPP message. All messages exchanged between the UEs are identified by including the session identifier within the SLPP message exchanged. The session establishment request may be the first SLPP message sent out and the session establishment response may be the response to the SLPP message. In this situation, the target UE provides the session identifier on the first message to a second UE. The responding UE (e.g. the anchor UE) responds back using the same session identifier and thus participates in the positioning session.

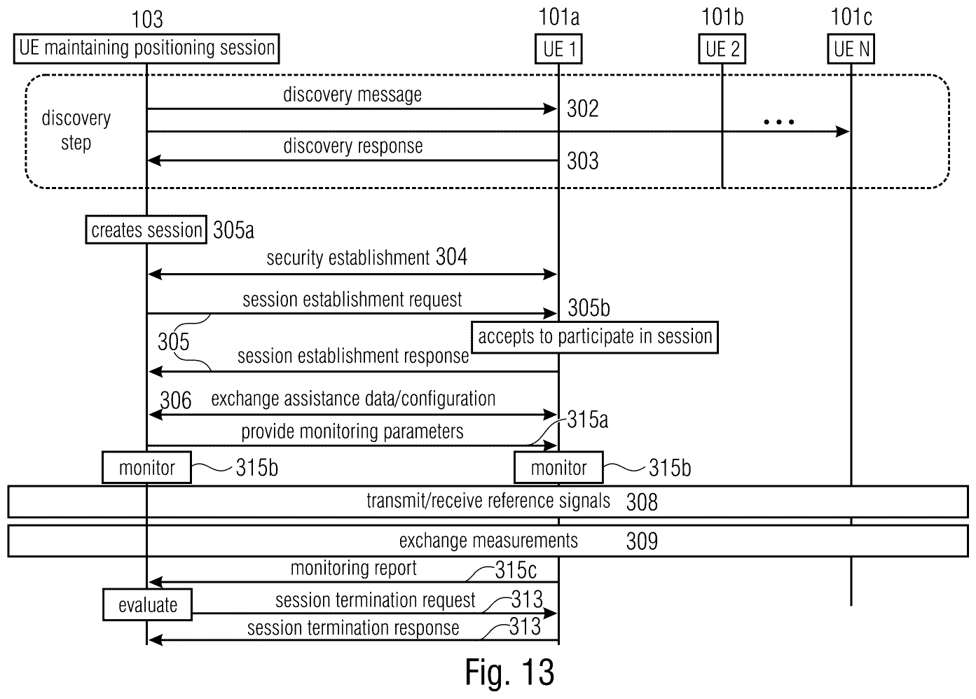

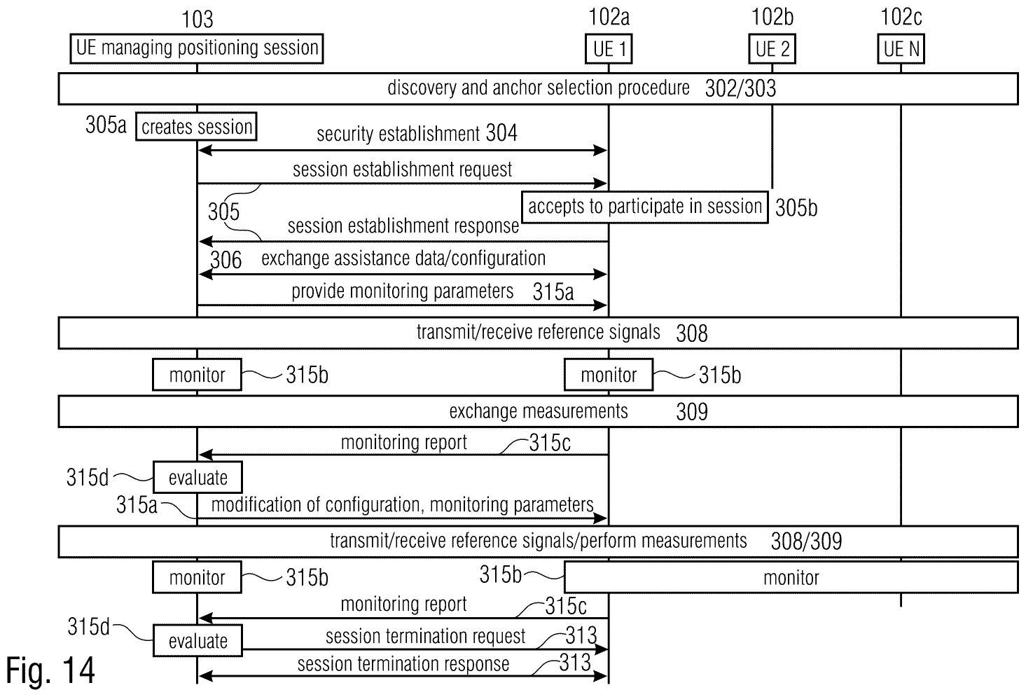

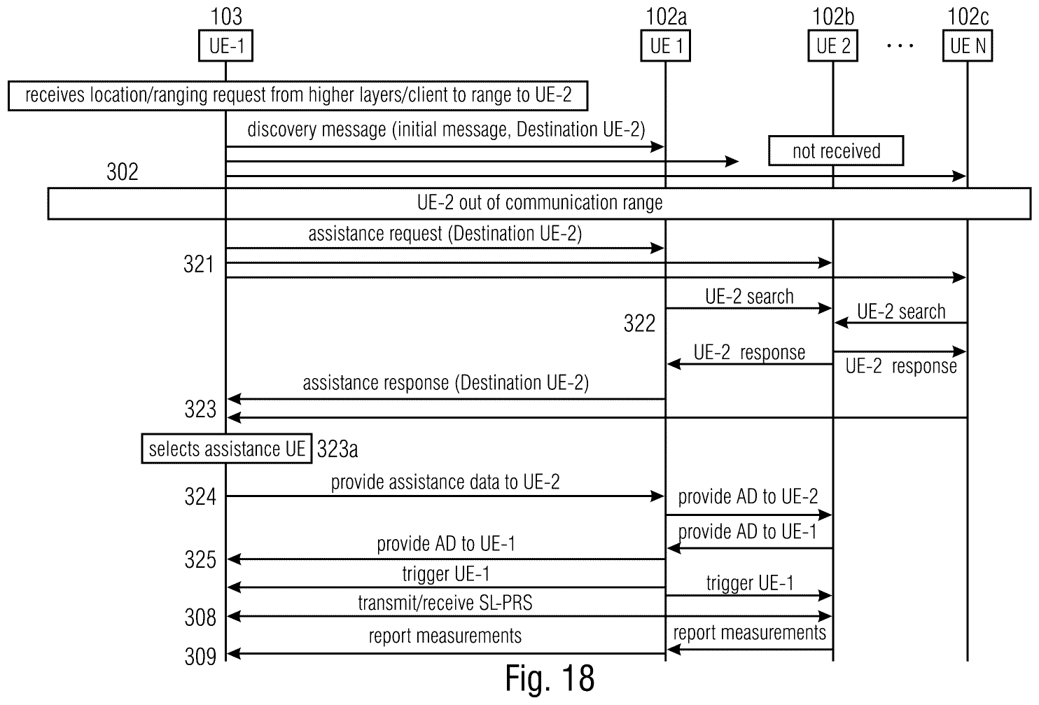

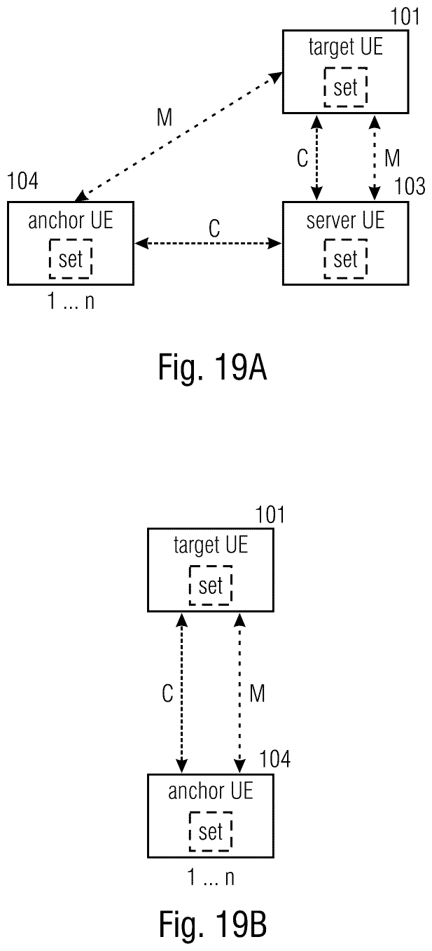

For the call flow diagrams, examples of how the embodiments described can be implemented. In the flow chart s of FIG. 9, FIG. 10b, FIG. 13, FIG. 14, FIG. 18 different interactions between the target UE 101, server UE 103 and the one or more anchor UE 102a-102c) are illustrated. Note, the interaction may also take place in different order than the one shown by FIG. 9, FIG. 10b, FIG. 13, FIG. 14, FIG. 18. The steps may take place simultaneously. One signalling message may contain the contents of one or more interactions, or the content of the interaction may be distributed across one or more message. Some of the response, although indicated as a request/respond form may also occur as unsolicited response. Some of the indicated steps may also occur implicitly, as a result of earlier procedures having taken place while (for example) establishing the initial connection between two entities or registering with the network.

The UE then may optionally, subject to its capability and/or configuration, announce its availability as a positioning server to at another UE or a group of UEs.

In one variant, the selection criteria for the server UE may be that the server UE is in coverage or in partial coverage. Based on the selection criteria, the UE 102a and 102c take over the anchor, wherein the UE 102b does not participate in the sidelink positioning, for example. This information is provided as response in the step 303. After that, security establishment steps 304, session establishment steps 305, exchange assistance data/configuration/signaling 306 may follow. Optionally, a further anchor UE may be added to the session as illustrated in the steps 307.

In line with this variant the server UE may coordinate the allocation of resources and/or perform measurements on positioning reference signal. The server UE may then provide the measurements to the location server on the network, wherein the network may combine one or more of measurements pertaining to the target UE to compute the position. The network node may then be able to associate the measurement reported by a server UE to a particular target UE by associating with the session identifier used by the server UE. The server UE may assign the session identifier by itself or may acquire the session identifier from the network node. Note, the information of the session identifier is used to associate the measurements pertaining to particular target UE. After that, the transmission and reception of the reference signal (cf. 308) and the reception of the measurements from the anchor UEs and/or the assistance UEs (cf. 309) are done. Based on this, the position/ranging can be computed and provided to higher layers or clients in this step 310.

In one variant, the target UE may request a server UE to manage its positioning session and/or accept the offer from the server UE to manage its positioning session after discovering at least one server UE and/or selecting at least one server UE to request the location service with. The request may be sent by sending out a dedicated message to establish session, wherein the message contains a location service request. The location service request may indicate the type of location service requested, e.g. absolute position in local or global coordinates, relative position, range, velocity. The location service request may further contain an indication of the quality-of-service. If the location service is missing a quality of service, then the request may be interpreted as a location service on a best effort basis. The target UE initiates a timer after sending a request to initiate the session. If the target UE receives a response from the server UE before the expiry of the timer, then the target UE participates in a positioning session with the server UE. Otherwise, it may initiate session establishment procedure with another server UE or the target UE may carry out the session management itself.

Alternatively, the server UE may have already created a session in response to the discovery message from the UE. wherein the discovery message may have indicated a location request with quality of service. In this case, the server UE initiates a session and sends a message indicating the target UE indicating the created session, for example, by sending an identifier identifying a session. The server UE initiates an expiry timer and waits for the target UE to accept the session. The target UE may in response to the discovery message containing information about the session, respond to the server UE before the expiry of the timer. The timer may be preconfigured or signaled to the UE within the response to discovery message. If the server UE does not receive a response accepting the session before the expiry of the session, the server UE terminates the session.

### Anchor UE

Below, further aspects of the anchor UE will be discussed. Each aspect may be used for its own or in combination. Thus, the below description of the anchor UEs corresponds to descriptions of different embodiments.

### An Anchor UE (According to Embodiments)

Receives a configuration from a network entity (e.g. LMF, serving-cell) and/from or a second UE or retrieves a preconfiguration stored in a UE, ME or UICC, wherein the configuration provides at least one parameter (such as time/frequency allocation, sequence) of the sidelink reference signal the anchor UE is configured to transmit
Transmits the sidelink reference signal according to the configuration.

An anchor UE which receives according to embodiments additional information indicating the conditions the anchor UE is configured to transmit, wherein the additional information is any one of the following:
Update existing parameter of the configuration of reference signal configured to the UE or stored at the UE.
Trigger the start or stop of the transmit signal.
Configuration indicating the condition on which the anchor UE is expected to transmit.

The condition for updating the existing parameter of the configuration of the reference signal for sidelink may be provided by:
1) RRC-Reconfiguration received from a serving cell
2) RRC-Reconfiguration received from a second UE (e.g. server UE).
3) Sidelink positioning protocol and/or location positioning protocol
4) MAC-CE from a MAC-entity, wherein the MAC-layer indicates a parameter and a value assigned to the parameter to be updated.
5) Update of parameter by receiving physical layer device control information (DCI) signaling, wherein the value of the parameter is encoded within the DCI and/or indicated within the DCI.
6) Update of parameter by receiving physical layer device control information (DCI) signaling, wherein the value of the parameter is encoded within the DCI and/or indicated within the DCI.

The trigger to start or stop may according to embodiments be provided by:
1) Higher layer signalling from SLPP or RRC or session-layer or application layer, wherein the trigger signal indicates the OFDM symbol and/or subframe the time where from when the configuration is to be applied.
2) MAC-CE from serving cell or second UE indicating trigger of a configuration of sidelink reference signal, the OFDM symbol and/or subframe from when the configuration is to be applied.
3) MAC-CE from serving cell or second UE indicating the trigger of configuration, wherein the signal is transmitted on the next possible instant corresponding to periodicity and offset of the configuration of the reference signal.
4) SCI or DCI indicating the anchor UE to start transmitting

The configuration of the conditions on which the anchor UE is expected to begin transmitting a reference signal is according to embodiments provided:
1) In response to measurement of RSRP above a certain threshold on a certain configured resource
2) In response to another condition like a condition defined by a configuration or preconfiguration.

The configuration of the conditions on which the anchor UE is expected to begin transmitting a reference signal may be provided to the UE by:
1) Preconfiguration in the mobile equipment or stored within a mobile equipment.
2) Preconfiguration in the UICC.
3) Configured by a server UE monitoring or managing the anchor.
4) Configured by a network entity
5) Preconfigured by a network entity.

The anchor UE, provides the configuration of reference signal to a second UE, that a second UE can monitor or a second UE can configure a third UE to monitor.

The anchor UE, provides the configuration of reference signal to a second UE, that a second UE can transmit or a second UE can configure a third UE to transmit the said reference signal to the anchor UE.

The anchor UE, wherein the anchor UE provides according to embodiments a second entity a list of preconfigured reference signals that the anchor UE may transmit, if requested by a second entity. The anchor UE, wherein the anchor UE provides according to embodiments a second entity a list of preconfigured reference signals that the anchor UE may perform measurement on, if requested by a second entity.

The preconfiguration reference may include one or more parameters that cannot be changed by other UE and/or one or more parameters that may be changed by other UE.

The anchor UE checks according to embodiments whether the entity triggering the transmit of sidelink reference signal is allowed to configure and/or trigger certain reference signal, wherein.
The UE transmits the reference signal as configured and/or triggered by the second entity if the anchor UE determines the UE is allowed to configure and/or trigger.
The UE rejects the configuration and/or provides alternative configuration if the entity is not allowed to configure the reference signal for the given UE and/or provides an error message indicating that reason why the anchor UE cannot transmit the given reference signal.

The checking could include:
1) Authorization of the second entity to request positioning reference signal, provided to the UE within the ME, UICC or provisioning.
2) Authorization of the second entity to request positioning reference signal, obtained by the UE when the UE registers with the network. The information provided could be based on the information stored in the UICC or ME of the UE or retrieved from UDM in the network.
3) Whether the second UE belongs to a certain group of UEs
4) Whether the second UE is registered with the same PLMN as the anchor UE

The reason for rejection included by the anchor UE may include one of the following:
1) The configuration of reference signal cannot be transmitted by the anchor UE because of other assignments (e.g. measurement gaps, DRX pattern, PSSCH assignments, PUSCH assignments, etc)
2) The second entity is not allowed to configure the anchor UE and/or make an on-demand request of a configuration.
3) The UE does not support the parameters requested.

Note, monitoring between anchor UE and target UE may be based on target UE measuring the reference signal configured to the target UE for monitoring purposes.

### Located UE Discovery & Selection

When Sidelink Positioning is applied for Target UE in a SL-MO-LR, SL-MT-LR, 5GC-MO-LR or 5GC-MT-LR procedure, Located UE(s) may according to embodiments be discovered and selected: When LMF determines to apply Sidelink Positioning for Target UE, LMF triggers the Target UE (request) to perform discovery of the Located UE. Or When the Target UE determines to apply Sidelink Positioning, the Target UE triggers the discovery of the Located UE.

NOTE: The role of being “Located UE” is dynamic and can change over time, in particular if the Located UE is moving. Hence, the discovery results need to be refreshed if there is a (significant) delay between discovery and initiating of a ranging procedure with a discovered Located UE. How often this is done is up to UE implementation.

### Measuring Roles of Anchor UE

### An Anchor UE (According to Embodiments)

Receives a configuration from a network entity (e.g. LMF, serving-cell) and/from or a second UE or retrieves a preconfiguration stored in a UE, ME or UICC, wherein the configuration provides at least one parameter (such as time/frequency allocation, sequence) of the sidelink reference signal the anchor UE is configured to measure
Performs measurement on the sidelink reference signal according to the configuration

An anchor UE which receives according to embodiments additional information indicating the conditions the anchor UE is configured to perform measurement on, wherein the additional information is any one of the following:
Update existing parameter of the configuration of reference signal configured to the UE or stored at the UE.
Trigger the start or stop measurement.
Configuration indicating the condition on which the anchor UE is expected to begin measuring and/or begin reporting to a second entity (e.g. the server UE).
Configuration indicating the condition on which the anchor UE is expected to begin transmitting a sidelink reference signal, in response to the outcome of the measurement performed.

The anchor UE checks according to embodiments whether the entity requesting the measurement of sidelink reference signal is allowed to receive the measurement from the anchor UE.
The UE returns an error and/or error cause if the receiving entity is not authorized to receive the report.

The error cause may include:
The second UE does not have security enabled.
The second UE is not within authorized UE list according to preconfiguration and/or configuration received by the anchor UE.

The configuration of the conditions on which the anchor UE is expected to begin measuring and/or reporting measurement on a reference signal may be provided to the UE by:
1) Preconfiguration in the mobile equipment or stored within a mobile equipment.
2) Preconfiguration in the UICC.
3) Configured by a server UE monitoring or managing the anchor.
4) Configured by a network entity
5) Preconfigured by a network entity.

An anchor UE may be an active UE and/or a monitoring UE.
In monitoring role, the UE monitors the conditions, makes measurement on a best-effort basis.
   A UE does not need to notify failure to transmit or receive.
In active positioning anchor role, the UE monitors the condition, makes measurement according to the configuration provided by the server UE.
   The UE needs to report to the server when the measurement and/or transmission cannot be made as requested.

An anchor UE, may be configured to select a configuration from a plurality of configuration applicable for an anchor UE, to move an anchor UE from monitoring anchor role to active positioning anchor role,

wherein in monitoring anchor role, the UE may transmit a positioning configuration with lower bandwidth and/or lower periodicity and/or provide measurement reports either with smaller reporting rate and/or event driven to a second entity.
Wherein within the active positioning anchor role, the UE may transmit a positioning configuration with higher bandwidth and/or higher perioridicity of reference signal and/or provide measurement reports more frequency to the second entity.

An anchor UE monitors according to embodiments the availability of resource usage in the area the anchor UE is located in, by monitoring any one of the following:
RSRP or RSSI on RE configured or derived from a configuration provided to the UE.
SCI decoded by the anchor UE

An anchor UE may report the most suitable resource that may be assigned by the server UE to the said anchor UE based on the report of monitoring.

Information provided by anchor UE to a second UE (unicast) or a group of UEs (broadcast/groupcast)
Support for measurement and/or transmitting reference signal according to QoS criterion
Support for measurement on best effort basis.
Who can request the anchor UE to range with it.

### Anchor Selection

A UE managing a positioning session for a target UE or the target UE itself may select at least one anchor UE from one or more anchor UEs available for the server UE to select for a given target UE applying an anchor selection criteria, so that the requested QoS for the location service may be fulfilled. The anchor selection criteria may be dependent on UE implementation, wherein the server UE may take into account one or more of the parameters acquired by the UE in selecting the anchor UE.

The anchor selection criteria may be based on the QoS requested by the location service client and/or by the positioning method requested. For example, the Required positioning QoS may be used as anchor selection criteria. The selection criteria may according to further embodiments be defined by a combination of one or more parameters and/or information, which the server UE and/or a target UE may acquire about the anchor UE by various means. A server UE and/or a target UE may acquire the information about one or more anchor UEs by any one of the following means:
1) Receiving and/or decoding the broadcast and/or groupcast messages sent by the anchor UE
2) Receiving response from one or more anchor UEs in response to discovery message sent by the server UE.
3) Using assistance data provided by the network via another UE in coverage, wherein the assistance data may indicate the availability of a server UE in a certain validity area.
4) By exchanging keys while establishing security-during ciphering and integrity protection.

The anchor UE may provide the server UE or the target UE the following information as a part of discovery procedure. The anchor UE may announce its capabilities via broadcast and/or groupcast and/or unicast to the server UE or the target UE. The anchor UE may provide the information either as unsolicited transmission to the target UE or in response to capability request by a server UE or a system information request by the server UE. Likewise, the anchor UE may also provide status report in a similar manner. Alternatively, the status report could be transmitted as capabilities of a UE which may vary with time. Below some examples are explained:
1) An anchor UE may be selected by the server UE or the target UE using one or more of the parameters determined and/or acquired by the server UE or the target UE, in order to determine an anchor node. The parameters could include: Anchor role supported by the UE.

The UE acting as an anchor UE may be pre-configured and/or configured by the network to have capabilities to act as an anchor. The anchor may indicate its anchor capabilities to the target UE by indicating the anchor as one of the roles supported by the UE.

The anchor UE indicate to other UEs that it supports the anchor role in the list of its supported function during the discovery. The authorization for a UE to act as an anchor UE within a given PLMN may be signalled to the UE by a network node (for example, the AMF) or stored in the UICC card as part of provisioning. The information about the ability of the UE to act as an anchor UE may further be stored in unified data repository within the core network. The anchor UE may be authorized for its role as an anchor UE, before the network node provides the anchor UE as one of the candidate anchor UEs to a target or a server UE as candidate list of anchor UEs. UE Positioning assisted by Sidelink Positioning and involving 5GC, the Target UE shall, for example, discover and select Located UEs that are in the same serving PLMN of the Target UE.
2) Line of sight condition between the target UE and the anchor UE

The server UE may configure the target UE to transmit a reference signal and indicate the anchors to measure the reference signal as a part of discovery procedure. The anchors may estimate LOS condition based on this discovery signal, and associate the response.
3) Bandwidth of the positioning reference signal which can be transmitted and/or received by the UE. The bandwidth influences the resolution of the correlation peak.
4) Update rate supported by the anchor UE.
5) The intended measurements (e.g. RSTD, RTT, TDOA, ToA, AoA, AoD) supported by the anchor UE.
6) Capability of the anchor UE to process sidelink measurements

This could include the number of simultaneous measurements that can be performed by the UE.
7) Location of the anchor UE

The server or the target UE may select an anchor UE based on the location of UE. The knowledge of location of an anchor UE may be used by the server UE to make a DOP estimate for a target UE. The server UE may have a rough estimate of the target UE location, for example, by range and/or angle estimate with respect to the server UE and/or via an indication provided by the target UE (e.g. V2X zone, area identifier, GNSS location etc). Thus, the UE location is according to embodiments one of the anchor selection criteria.

As shown in FIG. 2-5, not all anchor UEs may be static. The location of anchor UE may be estimated first, followed by the use of the location of the anchor UE to calculate the location of the target UE. The anchor UE, may indicate to other UEs, that its location is known. The anchor UE may compute its location or may trigger a location request (e.g. via sidelink positioning or to the LMF), when the UE determines that its known location needs to be updated (for example, the UE has determined that it has moved or the determined location does not have sufficient QoS (e.g. accuracy, variance or integrity).

The anchor UE may be configured with a scheduled location time request, wherein its position is updated at configured point in time. Likewise, the anchor UE may initiate MO-LR to obtain its location. On successfully obtaining the UE position with required quality, the UE shall indicate that its location is available to other UEs. If the position is degraded or if the UE has not successfully obtained the position with required quality, or if the UE does not wish to expose its position to other UEs, the UE may indicate the unavailability of known location.

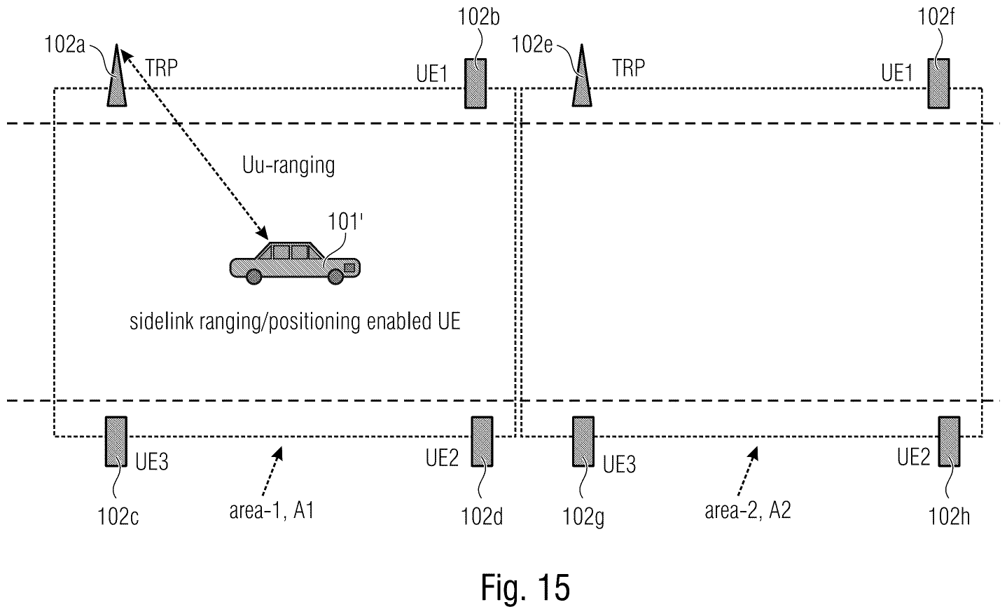

In some scenarios, some of the UEs may be stationary. For example, In FIG. 15, the U (102b-d) may be operator or roadside units. The information about the location may be stored in a database, and the information about such UEs with their location may be available to the network entity (e.g. the LMF), which may provide this information further to server and/or target UEs to support discovery of the anchor UEs.
8) Mobility state of the target UE and/or anchor UE and/or server UE

The server UE or the target UE may select anchor UEs that are static (e.g. roadside units), semi-static (e.g. anchors deployed statically for a certain period of time such as during events or for a task (such as rescue operation)) or anchor UEs that are moving together with the server UE and/or the target UE.

As an example, the target UE and/or server UE and/or at least one anchor UE may be part of a group of UEs moving together. The group of UEs moving together may be configured by the application layer.
9) Group Membership of the target UE and/or the anchor UE and/or anchor UE

The server UE or the target UE may advantageously or exclusively select an anchor UE belonging to the same group as itself. The group could be associated to the same serving PLMN, same type of service as indicated by application layer, same OEM, to name a few examples. Thus, the serving PLMN is according to embodiments one of the anchor selection criteria.
10) Synchronization reference of the anchor UE (SyncRef UE)

For example, the server UE or the target UE may advantageously choose am anchor UE with a higher quality synchronisation reference. For example, if a UE is synchronized with its own internal clock, it may use the UE which is indirectly synchronized by a network node as a anchor UE over a UE which is using indirect synchronization.
11) Energy considerations at the anchor UE (e.g. power saving profiles, battery status)

For example, the server UE or the target UE may advantageously choose an anchor UE with lower current load or higher remaining battery power status over the UE having lower remaining battery power status, or a UE having a higher ON cycle in its DRX duty cycle.
12) Coverage and/or connectivity state of the anchor UE

For example, the server UE or the target UE may advantageously select an anchor UE in partial coverage over an anchor UE in out-of-coverage. Then the anchor UE send the measurement directly or via anchor UE to the network entity (e.g. LMF) which computes the final position of the target UE. Thus, the in coverage/not in coverage status is according to embodiments one of the anchor selection criteria.
13) Latency values on signaling link

The anchor UE and/or the server UE may estimate the latency on the signaling link between the server UE and the anchor UE. This may be estimated based on the discovery procedure or as a part of session with another UE.

According to embodiments the UE may be provided with a candidate list of anchors, as assistance data or provisioning. Stating from this list the selection can be made using above mentioned anchor selection criteria.

An optimum selection of anchor depends on channel condition between anchor UE and target UE. The server UE and/or location server and/or network entity may configure and/or request a measurement from one or more UE that may support UE role as an anchor. The entity may provide a configuration of a reference signal and/or a resource where the UE may perform the measurement. Furthermore, it may configure a certain reporting configuration for retrieving the measurement. The reporting may be reported periodically, or subject to a certain event. The measurement quantity (e.g. RSRP, ToA, LOS indicator) to be reported may also be provided to the UE. For example, an anchor UE may be provided a reference signal configuration and may be configured to report back if it detects RSRP above a certain range and that the anchor UE detects a LOS condition between the transmitter and the anchor UE.

A target UE may have provided a configuration of reference signal and/or it may have received a configuration of reference signal from the server UE, the configuration describing the resource and the reference signal where the target UE is expected to transmit. One or more anchor UE may be expected to measure this signal and report back to the server UE depending on the configuration provided.

Alternatively, the target UE before initiating a session may have initiated a sessionless ranging and/or positioning operation. This may have been done using configured or pre-configured assistance data, wherein the assistance data at least describes a configuration of reference signal and/or a resource within a resource pool carrying a reference signal. The configured assistance data may be attached to at least a validity criteria, wherein the validity criteria indicates a validity area, validity time, or validity conditions relating to measurement. A target UE may include the channel condition (e.g. RSRP on a certain reference signal between anchor UE and target UE, LoS condition, DOP estimate, etc) between itself and at least one anchor UE included in the preconfigured assistance data to the server UE.

In this example, in response to receiving at least one measurement report from either target UE and/or anchor UE, the server UE may select at least one anchor fulfilling the selection criteria and initiate a session between the anchor UE and a target UE.

In some cases, the server UE may have obtained certain parameters of selection criteria from an anchor UE and/or preconfigured assistance data and/or assistance data from the network and/or higher layers, which enable the server UE to select at least one target UE and initiate the session between the anchor UE and a target UE.

In case there is already a PC5 connection established between the server UE and the anchor UE, the UE may establish a separate PC5 connection between the server UE and the anchor UE, wherein the new connection is distinguished by use of a different Layer 2 Source ID and Layer 2 Destination ID combination than the one pre-existing. The anchor UE relates the signalling messages and assistance data for the session by means of the PC5 connection that is established.

In an alternate version, the server UE may utilize its existing PC5 connection. The messages corresponding to the new session established may be indicated by providing an identifier that identifies the session between the server UE and the destination UE.

A target UE may utilize certain preconfigured or configured assistance data to perform measurement on reference signals that are temporally or spatially available at the current location of the target UE. Alternatively, a target UE may have initiated ranging operations on a best-effort basis and may have obtained a coarse location estimate and/or measurement from at least one anchor node. This information may be provided by the target UE to the server, while discovering the server or initiating the session or on-demand from the server UE. The sessionless positioning or ranging may or may not have the same quality of service as the location request from the target UE, but this operation may enable the server UE to identify the potential anchors and/or potential configuration for an anchor. In line with this example, the server UE may initiate session with an anchor UE to add it to the session managed by the server UE.

A server UE may setup and maintain a signalling connection between a server UE and at least one anchor UE. A server UE may maintain a session pertaining to a target UE and/or a session for monitoring anchors.

In an example where an anchor is be associated with a monitoring session, where the server may configure the anchor to make at least one measurements on at least one reference signal. Furthermore, the server may configure the said anchor to perform reporting, either on a periodic, based on a trigger or event-driven based on measurement.

An anchor UE may indicate an timer to the server UE, wherein if no positioning session is requested and/or setup within the expiry of the timer the anchor UE ceases to participate in the positioning session. The UE may optionally send a session termination request for the monitoring session and/or terminate the PC5 connection between the server UE and the anchor UE. Likewise, the server UE may end the monitoring session between the server UE and the anchor UE.

### Coordination of Resources and Measurement Transfer

The server UE managing a session for a target UE may interact with an anchor UE and/or a target UE to identify a suitable configuration of resource for performing channel measurement between two UEs.

### Server UE Coordinating Centrally the Allocation of Resources Within the Session

The server UE may obtain allocation of resources in the transmit pool in configured the target UE and/or receive UE. The server UE may provide transmit and/or receive resources and/or configuration for transmit and/or receive resources for the UEs belonging to the session, taking into account the requested quality of services.

In an alternate version, the server UE may configure only the receive configurations for the UEs, and the server UE trigger at least one UE to transmit using the configured resource. All of the UEs except the UE signaled to transmit listen to the configuration and perform measurement. The UEs may be configured with reporting criteria and/or reporting configuration to the server UE. The UEs provide the measurements according to the reporting configuration to the server UE.

In line with this example, the configuration configured may be common for a group of UEs belonging to the session. The trigger for transmission, which may be carried by higher layer signalling or MAC-CE or physical layer signalling (e.g. SCI/DCI), may modify or complement a parameter for transmission. For example, a UE may be triggered to transmit a reference signal with a certain comb-offset applied. A second example, a UE may be triggered to transmit a reference signal using the configuration applied to a group of UEs, but the comb-offset may be determined based on the UE-identifier, for example, comb offset=mod (UE-identifier, comb_offset), where mod indicates the modulo operation.

### Sniffing the Environment for Resource Assignment in the System

In another variant, the server UE and/or a target UE and/or an anchor UE may perform measurement on resource pools configured and/or preconfigured to contain sidelink positioning reference signal. The configuration may be obtained by retrieving the configuration from one or more UEs and/or from system configuration and/or from preconfiguration stored in the server UE. An example of measurement could be RSRP or RSSI observed on the resource elements of the resources belonging to at least one resource pool in the system. The server UE could then identify possible combination of resources that could be used to perform channel measurements between two UEs.

In line with this example, the target UE can identify resources that are observed to be available and indicate the resources to the server UE. The target UE may report the resources that may be useful taking the QoS requirements associated with location request into account. For example, the UE may indicate resources that are observed unused which have a certain bandwidth and certain periodicity. Furthermore, the UE may indicate the resources where it may be able to perform measurement and/or the resources where it may be able to transmit and/or both.

In line with this example, the anchor UE may receive a request to scan for free resources indicating a certain QoS requirement. For example, the server may indicate the anchor UE to report the resources that have bandwidth higher than 20 MHz and occur with periodicity of 20 ms and belong to a certain resource pool for the anchor UE. Furthermore, the UE may indicate the resources where it may be able to perform measurement and/or the resources where it may be able to transmit and/or both.

The server UE may receive information from a target UE and/or an anchor UE about the resources that it is transmitting irrespective of the session, for example, as a part of another positioning session. This information may be useful for the server to reduce the number of dedicated transmissions needed positioning session. For example, an anchor UE may be part of a roadside unit, and it may be transmitting a reference signal on a periodic basis. This signal could be reused by a target UE (for example, to determine RSTD with another device (another UE or from a TRP).

The server UE may take into account the report provided by the server UE and/or the anchor UE to determine suitable resources for positioning of the target UE. Assistance data and/or configuration to transmit and/or receive the reference signals may be provided to the respective transmitter and receiver of the reference signals. The assistance data and the measurement configuration may be applicable to a particular session.

The anchor UEs and/or the target UEs may receive the signal and provide the measurement report to the server UE, associating the measurements with the positioning session.

A UE may be configured to transmit a reference signal in either periodic, semi-persistent or aperiodic basis. A server UE and/or a network entity may configure a second entity (e.g. a target UE, an anchor UE) to perform measurement on the aforesaid reference signal and/or a part of the aforesaid reference signal for the purpose of monitoring and/or ranging. The signal may be triggered autonomously by the UE, when the UE enters a preconfigured validity area, and/or within a certain time-interval and/or subject to a certain event (for example, the UE may be configured to monitor a second reference signal it is expected to receive, and transmit its own reference signal subject to the outcome of the measurement). Alternatively, transmitting the aforesaid reference signal may be triggered by the UE.

As a part of session maintenance and/or monitoring, the server UE may acquire the information from one or more UEs and attempt to utilize the reference signal they are already transmitting and/or are preconfigured to transmit for positioning purposes. For example, if the server UE determines that an anchor UE has a signal of 50 MHz it is transmitting already, it may utilize this information and provide information to the target UE to perform monitoring and/or measurements. In case the server is attempting to acquire RTT measurements, it may then only need to request the target UE to transmit a reference signal associated with the reference signal transmitted by the UE, and signal the anchor UE to perform measurement on this signal.

### Decentralised Operation

The server UE may indicate the target UE and/or the anchor UE to employ carrier sensing operation, wherein the transmitter may listen to the channel and identify the resources that they deem free.

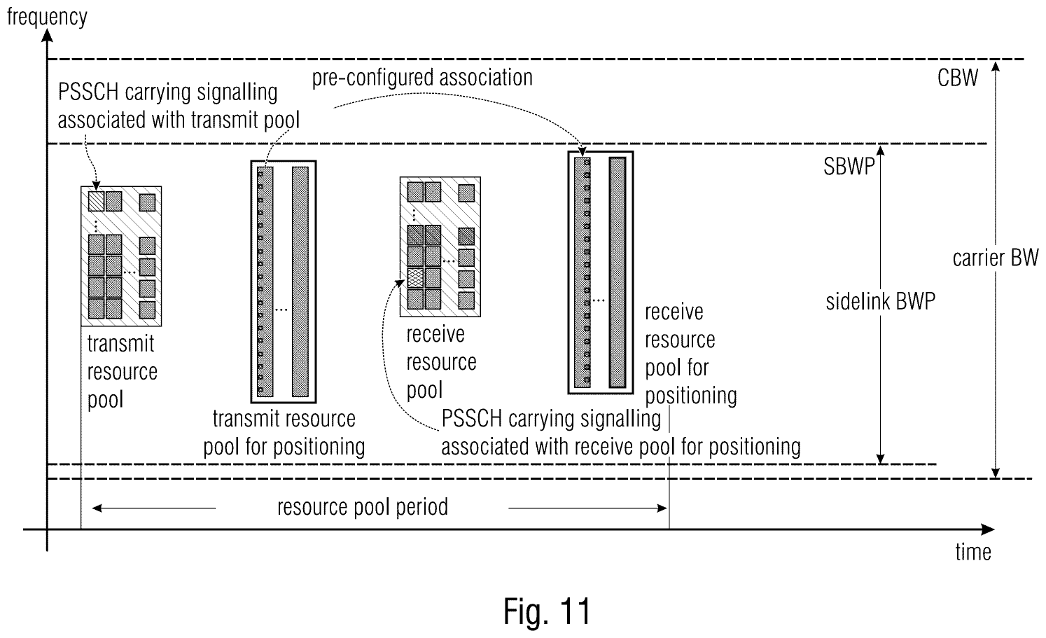

FIG. 11 shows schematically the allocation of resource pools from the perspective of a UE. Here, a sidelink bandwidth part SBWP within the carrier bandwidth CBW is marked. The CBW and SBWP is defined by frequency (y-axis) and time (x-axis). During the resource pool period, the resource pool is transmitted where the PSSCH carries signaling associated with the transmit pool. Starting on this, a resource pool for positioning (cf. transmit resource pool for positioning) is available. A different PSSCH can carry signaling associated with the receive resource pool for positioning as illustrated by receive resource pool. In this example, the UE is configured with a transmit resource pool for positioning and/or a receive resource pool for positioning. A UE may transmit a reference signal if:
1) The UE observes that the transmit resource in a transmit pool is unused during a configured time window for sensing and/or
2) The UE observes that the receive resource in a receive pool mapped to the said transmit resource in the transmit pool is unused within a configured time window for sensing.

The resource is deemed unused if the RSRP measured on the resource is below a certain RSRP threshold.

In line with the above embodiment, the UE may only select resources from the resource pool which satisfy the quality of service used by the location client. The server UE may indicate the constraints on resource selection to the source and target UE.

The resource selected by the UE (target and/or source) for transmission in the transmit resource pool for positioning may be indicated to the counterpart by transmitting a signaling message in the transmit pool. The signaling message in the pool may contain information on the parameters of the positioning signal selected by the transmitting UE, so that the receiving UE can setup suitable receiver processing to measure the reference signal).

### Monitoring and Session Maintenance

A positioning session may be managed at the target UE and/or at a UE with positioning server functionality and/or at a network entity (e.g. the AMF). A session may be associated with a location request or a ranging request concerning a given target UE. A session may be identified with an identifier. The location request or ranging request may further have a quality parameter, such as accuracy requirement, update rate, integrity requirement and so on.

During the positioning session, the position of anchor and/or the target UE and/or the positioning server may change. As a result, the signal strength, LOS conditions between the UEs, dilution of precision and so on may change. Moreover, there may be changes in the environment where the UEs are located. As a result, the channel conditions, such as signal strength, line of sight condition may change. These changes may cause the existing selection of anchor to be less advantageous or may even not meet the QoS target. On the other hand, the change in channel conditions may make the larger number of anchors redundant.

Likewise, there may be change in connectivity situation of one or more UEs, which may result in change in role or authorization of one or more of the UEs participating in the session.

The entity managing the session (e.g. server UE, target UE, LMF) may support the following functionalities:
1) Monitoring the anchors
2) Adding anchor UEs and removing anchor UEs
3) Modifying the configuration of parameters for transmission and reception
4) Establishing quality-of-service constraints with one or more UEs
5) Assigning priorities to transmission and/or reception of positioning reference signals

In general, the UE shall prioritize transmission and/or reception of resources belonging to a higher priority session over resources belonging to a lower priority session, if there is conflict among the two. Furthermore, the UE shall prioritize transmission and/or reception of resources belonging to a session over the resources in a sessionless positioning.

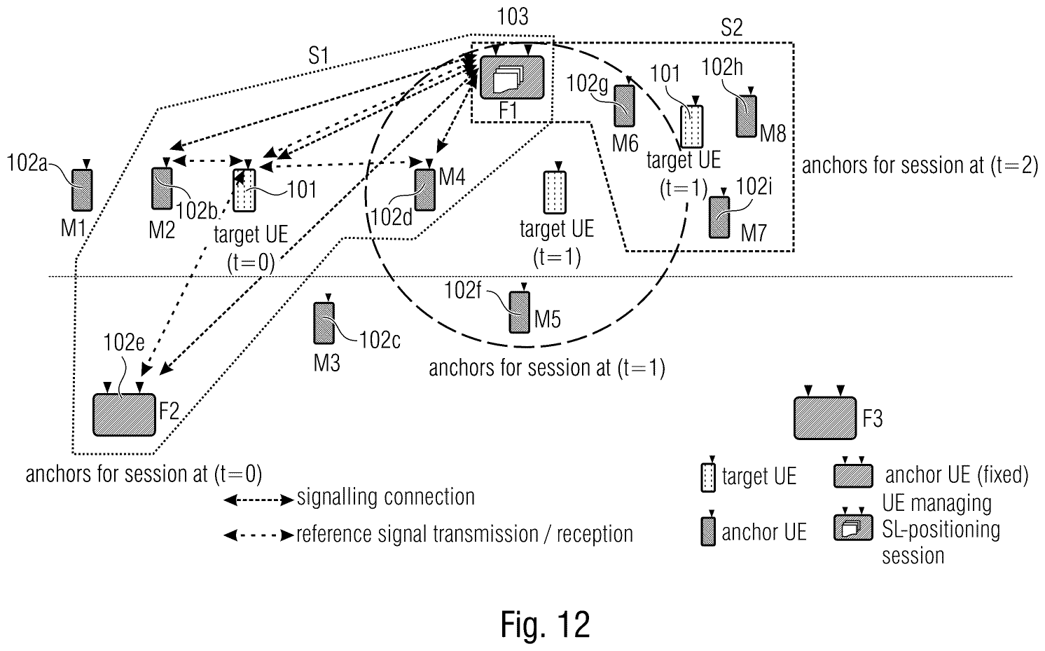

FIG. 12 shows a scenario where one anchor UE acting as positioning session coordinator acts as managing anchor UE for different sessions at different points of time. A first session is marked by S1 while a second session is marked by S2. Background is, as will be discussed in detail, that the UE constellation changes due to moving UEs. In an example in FIG. 12, the anchors M2 (102b), F2 (102e) M4 (102d) and F1 (103) are deemed the anchors for the positioning session associated with target UE at t=0. The anchors 102a, 102b, 102c, 102d are comparable to the anchors as discussed above. The anchor 102e is an anchor for which the position is known since the anchor is fixed. The anchor 103 is an anchor UE acting as positioning session coordinator.

As the UE 101 moves along, at t=1, anchors M2 (102b) and F2 (102e) are no longer part of the positioning session and anchor M5 (102f) and M6 (102g) are added. Likewise, at t=2, M4 (102d) and M5 (102f) are removed and M7 (102i) and M8 (102h) are added. Monitoring anchor UEs 102a-102i within a session and potential anchor UEs. May be done by the positioning session coordinator 103.

In order to determine the anchors to keep, the anchors to add and the anchors to remove, the UE managing the session either needs to monitor the anchors and/or needs to configure one or more UEs to monitor certain anchors and/or reference signals associated with certain anchors.

The UE acting as a position session manager, configures at least one anchor UE to transmit and/or receive a certain configuration of reference signal. The server UE may configure a monitoring session with an anchor UE, wherein the server UE may configure the anchor UE to transmit a certain positioning reference signal with a certain configuration for monitoring purposes. The server UE may configure the target UE to measure the monitoring signal emitted by the anchor UE being monitored by a UE. Furthermore, the server UE may trigger the UE to transmit a message to the server UE, the message indicating any one of the following:
1) LOS condition between the monitored anchor and the target UE
2) RSRP change on the configured reference signal, wherein
   a. The RSRP rises above the configured threshold
   b. The RSRP falls below the configured threshold
   c. The RSRP lies between the first threshold and the second threshold configured
3) Timing parameter change on the configured reference signal, wherein
   a. The timing parameter rises above the configured threshold
   b. The timing parameter falls below the configured threshold
   c. The timing parameter lies between the first threshold and the second threshold configured

The timing parameter may be ToA between anchor and target UE or RSTD between the anchor and one other node (e.g. another anchor UE or TRP)

The server UE may configure a monitoring session with an anchor UE, wherein the server UE may configure the target UE to transmit a certain positioning reference signal with a certain configuration for monitoring purposes. The server UE may configure one or more anchor UEs to measure the monitoring signal emitted by the target UE. Furthermore, the server UE may trigger the UE to transmit a message to the server UE, the message indicating any one of the following:
1) LOS condition between the monitored anchor and the target UE
2) RSRP change on the configured reference signal, wherein
   a. The RSRP rises above the configured threshold
   b. The RSRP falls below the configured threshold
   c. The RSRP lies between the first threshold and the second threshold configured
3) Timing parameter change on the configured reference signal, wherein
   a. The timing parameter rises above the configured threshold
   b. The timing parameter falls below the configured threshold
   c. The timing parameter lies between the first threshold and the second threshold configured

The timing parameter may be ToA between anchor and target UE or RSTD between the anchor and one other node (e.g. another anchor UE or TRP)

### Adding and Removing Anchor UEs

FIG. 13 shows a procedure comparable to the procedure as discussed with respect to FIG. 9, wherein this procedure is made under the assumption that a position session is already established and the UE 103, i.e., the positioning session coordinator maintains the positioning session. The discovery steps 302 and 303 are continuously performed so that the corresponding messages are exchanged between 303 and the respective target UEs 101a, 101b and 101c. In case of a change, a session may be created or updated (cf. step 305a). After that the steps 304 and 306 may follow. During the proceedings, new session establishment requests and session establishment responses 305 may be used to accept participants in the session (cf. 305b).

Of course, the illustrated method may comprise the steps 308, 309 of transmitting and/or receiving reference signals and exchanging measurements. At the end of the session, a session termination request and a session response may follow as illustrated by the steps 313. According to embodiments, a monitoring may be performed. The monitoring comprises providing monitoring parameters by the UE 103 (cf. step 315a) performing the monitoring, e.g. at the UE 103 or the UE 102a as highlighted by the step 315b and reporting on the monitoring (cf. step 315c). Below, details for the discussed managing steps will be given.

FIG. 14 shows an enhanced method, where monitoring configuration is provided to enable maintaining the anchors and updating configuration according to embodiments. The method comprises the following steps performed by the entities 103 (UE managing/maintaining positioning session) and the UEs 102a to 102c participating in the positioning session:
302 and 303 illustrated as one proceeding having the goal to create the session 305a
Security establishment 304
Exchanging assistance data/configuration 306
Session establishment request and session establishment response 305 with the goal that participants are accepted (cf. 305b). Here in step 305b of access to participate in session, the UE 101b is accepted.
After exchanging assistance data/configuration (cf. step 306) the reference signals may be transmitted and/or received in the step 308, so that the measurement can be performed and reported in step 309. These steps 308 and 309 may be repeated as illustrated by the second reference numerals 308/309.
Between the different exchange of the reference signals and measurements 308 and 309, a continuous monitoring may be performed. The corresponding steps are marked by the reference numeral 315a, 315b and 315c. As illustrated, these steps may be repeated. During the repetition, a modification of the configuration/monitoring parameters may be done based on an evaluation 315d.
At the end of the session, the session determination 313 may be done.

In response to the measurement report received by the server UE from an anchor UE and/or target UE, depending on measurement report, the server UE may do any of the following:
1) Remove the UE from monitoring session (for example, if the RSRP falls below the configured threshold) and/or terminate the PC5 connection (for example, if there are no other services using the PC5 connection).
2) Increase or decrease the periodicity of reporting.

For example, the anchor may report a reduction in RSRP, which may be associated with LOS changes or that the anchor is further away. This may entail less monitoring of such links.
3) Add the anchor UE to the positioning session, wherein the anchor UE may be reconfigured to transmit and/or receive signals with configuration enabling the QoS constraints to be met.

For example, the anchor UE may have been configured to transmit a reference signal with a bandwidth of 20 MHz with 1000 ms periodicity as a monitoring signal, and after fulfilling the selection criteria to be an anchor, the server UE may reconfigure the UE to transmit a reference signal with a bandwidth of 100 MHz with 20 ms periodicity.

### Monitoring Signalling Links

The server UE may configure an anchor UE to monitor certain parameters on the signalling link between the server UE and the said anchor UE. The parameters to be monitored by the anchor UE on signalling Ink and/or reported to the server UE may include
1) RSRP change on a configured reference signal (e.g. DMRS), wherein
   a. The RSRP rises above the configured threshold
   b. The RSRP falls below the configured threshold
   c. The RSRP lies between the first threshold and the second threshold configured
2) Timing parameter change on the configured reference signal, wherein
   a. The timing parameter rises above the configured threshold
   b. The timing parameter falls below the configured threshold
   c. The timing parameter lies between the first threshold and the second threshold configured
3) Signalling latency on the signalling link
4) Parameters of link quality such as BLER, retransmissions rate, modulation and coding rate used, number of resources used . . . etc

The server UE may use the measurement on the signalling link to evaluate the situation that the anchor UE may be removed from the session.

A server UE may configure a timer, which is reset every time a signalling message from an anchor is received. On expiry of such timer and/or on degradation of signalling link quality (e.g. degradation of latency beyond what is needed for supporting the QoS parameters), the server UE may remove the UE from positioning session for the target UE.

An anchor UE may configure a timer, which is reset every time a signalling message from the server is received. On expiry of such timer and/or on degradation of signalling link quality (e.g. degradation of latency beyond what is needed for supporting the QoS parameters), the anchor may end the session with the server UE.

The server UE may configure a target UE to monitor certain parameters on the signalling link between the server UE and the said anchor UE. The parameters to be monitored monitored by the target UE on signalling Ink and/or reported to the server UE on signalling Ink may include
1) RSRP change on a configured reference signal (e.g. DMRS), wherein
   a. The RSRP rises above the configured threshold
   b. The RSRP falls below the configured threshold
   c. The RSRP lies between the first threshold and the second threshold configured
2) Timing parameter change on the configured reference signal, wherein
   a. The timing parameter rises above the configured threshold
   b. The timing parameter falls below the configured threshold
   c. The timing parameter lies between the first threshold and the second threshold configured
3) Signalling latency on the signalling link
4) Parameters of link quality such as BLER, retransmissions rate, modulation and coding rate used, number of resources used . . . etc

The server UE may use the measurement on the signalling link to evaluate the situation that the server UE may need to handover the session to the second UE and/or jointly manage the session.

An anchor UE may signal the UE managing the session to end the session for a given target UE, if the anchor UE is no longer able to participate in the positioning session for the given target UE. The conditions may include:
1) The anchor UE needs to transmit and/or receive positioning reference signal for a higher priority positioning service than the one it is currently participating in. For example, for transmitting and/or receiving positioning signals that conflicts with the transmission of signals for the current positioning session.
2) The anchor UE has power constraints, e.g. battery remaining
3) The anchor UE is no longer authorized to transmit.

Monitoring the positioning session may indicate that the GDOP is not suitable with the current constellation available for the given position of UE and/or anchors. The session monitoring UE may indicate in the anchor discovery procedure, further criteria for new anchors sought. The anchor discovery procedure may indicate a potential anchor node the selection criteria: wherein the selection criteria could include:
1) RSRP range of a certain reference signal
2) Relative position to a provided reference point

An anchor UE and/or a target UE may report its change in coverage status to the server UE. In particular, the target UE may indicate handover of the positioning session to the location server in the network when the target UE moves from partial coverage and/or out of coverage status to in-coverage or partial coverage status.

A UE managing a session may monitor constraints at other UE for transmitting and/or receiving and/or processing positioning reference signals for computing the target UEs position. The constraints may include the remaining battery power, processing load, and so on. A UE may be removed from a list of anchors for a given target UE and/or configured to transmit and/or receive less often and/or with different parameters (e.g. reduced bandwidth), if the UE has battery power below the threshold and/or processing load over a configured threshold.

### Handling Priority Issues

The discovery message or connection requests between any two UEs may be indicated with a priority where certain values indicate an urgency with which the counterpart is seeking a service. Provided that priority is indicated in a scale ranging from 1 to 100, the lower band could indicate low priority service.

A UE may be configured with a threshold value for priority, which entails a UE to provide service if the request is coming from a certain group identified by an identifier (for example, the same group as the UE, same manufacturer, same PLMN, same application . . . etc) if the requesting UE is indicating priority higher than the threshold value.

A UE may be configured with a threshold value for priority, which entails a UE to provide service (e.g. as anchor/server) corresponding to its capability and/or provisioning if the request is coming from any UE if the requesting UE is indicating priority higher than the threshold value.

A UE may be configured with a threshold value for priority, which entails the UE to drop its own services unless they have higher priority, in favour of the request from a second UE if the requesting UE is indicating priority higher than the threshold value.

A UE may be configured with a threshold value of priority for enabling override of privacy. These may be special values that are configured to support public safety, regulatory and/or emergency services. For example. performing ranging to another UE as a part of a rescue operation.

Adding anchors and target UE from a sessionless operation and/or from another session.

The sidelink positioning server UE may request to add one or more than one UE simultaneously to the positioning session.

For example, a group of UEs may be associated to a session with a UE managing the session. This may for example be a group of UEs travelling in a certain direction. There may be a second group of UEs associated with a second group, where a second UE may be managing this session. This group of UEs could be as group of UEs forming a group of roadside units located at a certain area, or this may be a group of UEs of a fleet of vehicles travelling from opposite direction with respect to the first group. The two groups of UEs may interact with each other to add UEs, wherein at least one session may include at least one UE from the other group. The at least one UE from the other group may exchange assistance data and trigger conditions for adding at least one other UE from the group.

Similarly, a UE may initiate sessionless positioning initially at a certain location, using its preconfigured assistance data to get an initial position. This may indicate suitable anchors and their configuration. The UE may use this information to form a session, or indicate this information to a server UE while requesting a positioning session with the second UE. The ability to use the measurement from the sessionless operation may reduce setup latency. At least one UE within a session may be running a decentralized algorithm (e.g. an extended Kalman Filter). This involves estimation of states and/or obtaining measurements and exchanging the measurements. The exchanged measurement and their covariances could be a basis for reducing the number of anchors involved in positioning from the merged session. For example, k out of N anchors that have least covariance and/or los condition could be used. Likewise, the DOP can be computed with the estimated information and the UEs could be put into monitoring mode or active ranging mode. An algorithm running inside the server UE may be able to utilize the information it has obtained from one or more sessions. For example, the server UE may have obtained range information between anchors from a separate session.

### Information Broadcasted About an Anchor UE

Some information may be broadcasted by network and/or an anchor UE and/or by a second UE. The information broadcasted and/or groupcasted may include one or more of the following:
1) Position of the UE
2) Position covariance of the UE
3) Velocity estimate of the UE
4) Sensor data (e.g. Accelerometer, Magnetometer, Tachometer)
5) Reference signal used for detecting the anchor UE (e.g. used for monitoring)
6) Transmit and/or reception pools of UE.

The information may be broadcasted by the same UE, by a different UE (e.g. in server UE role) or by network. The broadcasted information may be encrypted, thereby limiting access to at least one UE in the system.

An example of the situation where a group of anchors can be added simultaneously to a session could include a sessionless ranging to obtain coarse position. This coarse position enables the UE maintaining the session to select the UEs taking into account their capabilities and the QoS requirements. The coarse position and/or ranges obtained from sessionless operation, wherein the sessionless sidelink operation could be carried out in a best effort basis (either as a standalone method or as a first step before establishing the session-based operation with quality of service requirements), could reduce the number of anchors that a UE needs to discover.

### Removing Anchor UE

The anchor UE may be removed from the positioning session if the condition for the UE or a group of UEs added to the positioning session is no longer valid. In the previous example, it may happen when the first group of UE leaves the validity area of the second group of UEs forming roadside units. The UEs may interact with each other to request session termination for itself or on behalf of a group.

Alternatively, if no response is received from a UE within a configured timer, wherein the configured timer may be provided by the UE maintaining positioning session or a network entity maintaining positioning session, then the UE may be removed from a session. If the target UE requests session termination or is no longer reachable, then the session may be terminated.

### EXAMPLES

Setup of session using information based on validity area as shown by FIG. 15. FIG. 15 shows a UE having the shape a driving vehicle. The UE is marked by the reference numeral 101′ and may be the target UE. It is assumed that the UE 101′ is a sidelink ranging/positioning enabled UE performing Uu-ranging in the area 1 (cf. reference numeral A1). The area A1 is an area, where the further UEs 102a, 102b, 102c and 102d are available. For example, the UE 102a may be a transmission point, i.e., fixed anchor UE. For performing the sidelink ranging/positioning (cf. steps 308 and 309) for a target 101′, one of the UEs takes over the management function. This may be the target UE 101′ or the anchor UE 102a. Of course, the other anchor UEs 102b, etc. may act as positioning session coordinator. It is advantageous that the target UE 101′ takes over the managing function, since it can continue the positioning session using additional measurements as illustrated by FIG. 14, when the UE 101′ drives from area A1 to area A2. In area A2, the target UEs 102e to 102h are available, where here also mobile and fixed anchor UEs are used. The positioning session coordinator which drives from area A1 to A2 realizes by use of monitoring (cf. steps 315a to 315d) that new transmission points are available and updates the session by adding new anchor UEs to same as, for example, discussed in context of the approach of FIG. 12 or done by the step 305b. Additionally or alternatively to the monitoring, the discovery step 302 and 303 may be repeated.

Starting from the two areas A1 and A2 having the target UEs 102a to 102h, the above principle may also be done when a group G of UEs travels from area A1 to A2. The group of UEs comprises the target UE 101′ and additional target UEs 101′a and 101′b. The three UEs 101′ to 101′b participating in a positioning session, i.e., perform relative positioning within the group G, may also participate in a second partitioning session using the target UEs 102′. When participating in a positioning session within the group G, some UEs may act as anchor UEs and target UEs in parallel. Due to the second positioning session, by use of the anchor UEs 102a to 102h an absolute position for the target UEs 101′ to 101′b may be determined.

Setup of session using information based on validity area and UE grouping as shown by FIG. 16. ZZ4

### Assistant UE to Range Between Two UEs Not Within Hearbility Region

In an example scenario, a UE may receive ranging request to a second UE from a client or from its own higher layers. A UE may attempt to perform ranging with the second UE if its identifier is known. Alternatively, it may use a configuration of resource in a discovery pool, transmit pool or exceptional pool to attempt to range with UE2. The parameters of the reference signal may be preconfigured or configured. Additionally, if needed, the parameters may be complemented using higher layer signaling or information in the second stage SCI. For example, the ranging is done using the Layer-2 Destination ID of UE-2 which is known to UE1 via provisioning, application layer or by association.

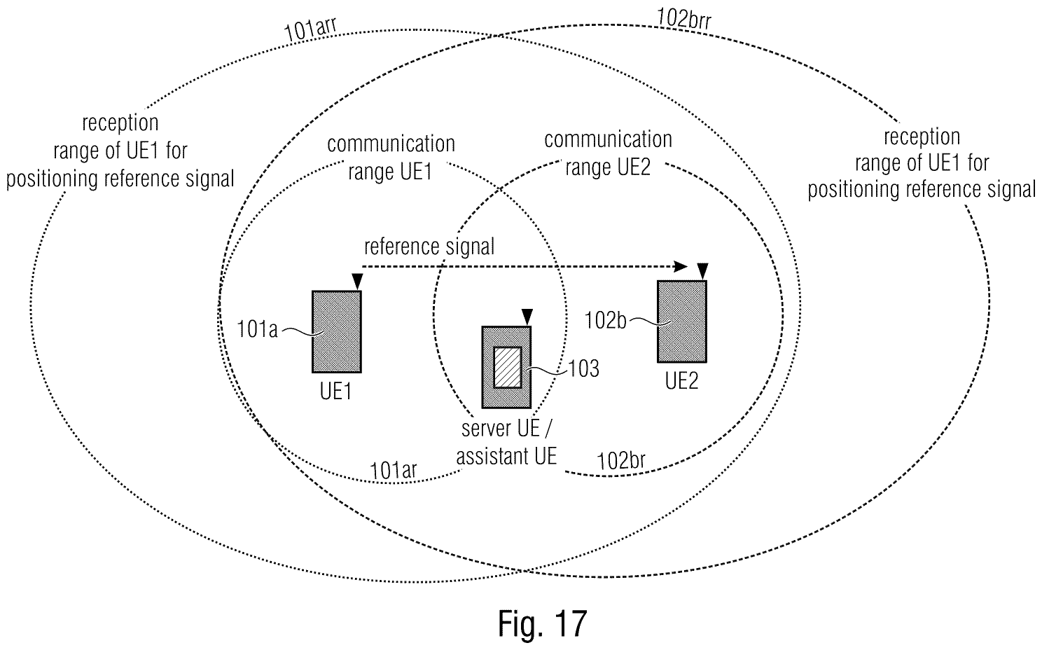

There may be situation where U2 may be outside the communication range of UE1. A second UE, taking a role of assistant UE may assist the UE1 and UE2 to range with each other. After the UE1 fails to get response from UE2, it may initiate assistance from a second UE to enable ranging. On receiving assistance request, one or more UE respond back to UE1. Alternatively, the potential assistant UE may attempt to establish signalling connection with UE-2. The UE1 may select one of assistant UE from the assistant UEs that respond back. The UE1 may provide configuration of positioning signals to the assistant UE which provides it to UE2. This may be optionally followed by triggering of UE1 and/or UE2 to transmit and receive ranging signals. The assistant UE may receive measurements from UE2 and provide it to UE1. This is illustrated by FIGS. 17 and 18.

FIG. 17 shows two UEs, e.g., target UEs marked by the reference numeral 101a and 102b. For the two UEs 101a and 102b, a communication range 101ar and 102br and a reception range 101arr and 102brr is illustrated. As can be seen, the communication range 101ar and 102br is not large enough so that the two UEs 101a and 102b communicating with each other so that they can directly start a positioning session where the UE 101a is a target UE and the UE 102b the anchor UE.

However, as illustrated by the reception ranges 102brr and 101arr and the communication ranges 101br and 101ar, the two UEs 101a and 102b are close enough to perform ranging. For this, the server UE 103 starts the ranging session, e.g., on request of one of the UEs 101a or 102b. The corresponding method is illustrated by FIG. 18 using the above-mentioned reference numerals. During the step 302, the UE 102b does not receive a discovery message, this means that the UE is out of communication range. Starting from this, an assistance request 321 can be output so that the UE 102a assists in the following steps 322 and responds to the assistance in the step 323. Starting from this, the UE 102a is selected as assistance UE 123a. Each UE, i.e., a target UE, positioning session coordinator or anchor UE can act as assistance UE. In the following steps 324 and 325, assistance data are exchanged so that the measurement can be done in the steps 308 and 309.

In an example, the target UEs and/or anchors may add a variable delay to the measurement and/or a variable timing advance or a virtual time advance (for example, generated by cyclically shifting a base sequence that is transmitted). Due to the unknown part added to the measurement or signal transmission, there will be errors in ranging purposefully added to the measurement results. A UE managing the session and/or the location server in the network entity may be able to acquire the provisioning and/or preconfiguration information and deduce the variable delay and correct the variable part. The variable part added may be fixed or time variable. If it is time-variable, then relation to derive the time-variable part shall be part of the provisioning and/or preconfiguration.

Any of the provisioning and/or preconfiguration information may be provided by the network to the UE when the UE registers with the network, and/or may be provided when a UE goes into connected mode with the network, or this may be part of the mobile equipment (preconfigured) or the subscriber information (stored in the UE—e.g. UICC). The preconfigured assistance data, for example, may assist sidelink positioning of UEs that are registered with different PLMNs. The preconfigured data that could be stored in the mobile equipment and/or the UICC may contain the pre-configured assistance data to be used in scenario where at least one of the anchor UE and/or the server UE may be controlled by a PLMN different to the PLMN stored in the target UE.

### General

In the above embodiments, it has been discussed that one UE out of a pool is selected as positioning session coordinator. In parallel, the selected UE can be the target UE or the anchor UE. In case it is the anchor UE, it can be a fixed or moving anchor UE. The positioning session coordinator is characterized in that it initiates and/or maintains a positioning session for a target UE, i.e., for another UE or for itself. The initiation can be done on explicit request, e.g., from a higher layer or from a second entity. Additionally or alternatively, the initiation may be done in response to a higher layer request of an internal entity, i.e., an application running on said positioning session coordinator.

As discussed above, sometimes an assistance UE may be used. The assistance UE may be one of the three mentioned UEs, i.e., may be the target UE, an anchor UE or a positioning session coordinator. Especially in a case when two UEs, e.g., a target UE and an anchor UE, are out of communication range but close enough to receive and transmit reference signals, the assistance UE may be the coordinator UE. In this case, the selection for the coordinator UE and the assistance UE is done dependent on the ability to communicate to the target UE and the anchor UE.

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and entailing input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 23 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation In hardware or in80oftwarere may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may b performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Target UE acting as positioning session coordinator and target UE, comprising a transceiver and a controller,
wherein the transceiver is configured to receive positioning request (from its higher layers or from a second entity),
wherein the controller is configured to create and/or maintain a positioning session for a target UE, wherein the positioning session comprises at least a measurement between the target UE and an anchor UE;
to select out of a plurality of UEs at least one anchor UE fulfilling one or more anchor UE selection criteria;
to coordinate assignment of at least one resource for transmission and/or for reception with the target UE and the anchor UE involved in the positioning session, wherein coordinating assignment comprises exchanging resource information on at least one resource to be used for transmitting and/or receiving a positioning reference signal;
wherein the target UE is configured to participate in a positioning session.

2. Target UE according to claim 1, comprising a transceiver, wherein the transceiver is configured to obtain information from a discovery message, provisioning (e.g. candidate list from network) or capability exchanges to analyze said information with respect to fulfilling one or more anchor UE selection criteria to select anchor UEs for positioning.

3. Target UE according to claim 1, wherein the transceiver is transmit or to receive on the at least one resource coordinated by the target UE.

4. Target UE according to claim 1, wherein the transceiver of target UE is configured to send a request to a server UE to be selected as broadcast and/or groupcast messages by the target UE or as discovery message sent by the target UE; and/or
wherein the transceiver is requested to perform discovery of other UEs (e.g. of the located UEs).

5. Target UE according to claim 1, wherein the target UE is configured to select the server UE or itself as server UE based on a configuration or per-configuration or assistance data provided by the network via another UE in coverage, wherein the assistance data may indicate the availability of a server UE in a certain validity area or wherein the target UE is configured to select the server UE or itself as server UE based on server selection criteria out of the following:
group membership of a group or moving group comprising the target UE and the server UE to be selected;
pre-configured and/or configured by the network;
included by a (pre-configured) list of candidates (-Location (absolute or relative) of the server UE to be selected;
selected by the target UE taking into account its own location;
mobility state of the target UE and/or server UE to be selected;
association to same serving PLMN, to same type of service as indicated by application layer, to same OEM, etc;
synchronization reference of the server UE (SyncRef UE);
Energy considerations at the server UE;
Coverage and/or connectivity state of the server UE;
Number of anchors currently managed by the UE;
DOP value for a given location;
Latency values on signaling link;
QoS classes pertaining to positioning supported by the server UE;
Support of session handover by the server UE; Condition that the server UE is in coverage or in partial coverage.

6. Target UE according to claim 1, wherein the transceiver of target UE is configured to be authorized to act as a server UE for a given target UE or to obtain a authorization for the target UE to select a certain server UE as its positioning server and/or to participate or initiate a security establishment procedure; and/or wherein the transceiver of target UE is configured to initiate the positioning session, especially by sending a request or selecting a server UE, and/or to repeat the initiation of the positioning session, e.g. with another server UE, upto fulfilling a server selection criteria or upon received response from the server UE; and/or wherein the transceiver is configured to transmit a request or a discovery massage or a positioning session establishment request or a positioning session establishment request as response to a discovery response massage and/or to receive a discovery response massage from a server UE if the server UE is capable of acting as positioning session coordinator or positioning session establishing response if the server UE has created a positioning session.

7. Target UE according to claim 1, wherein the transceiver is configured to perform at least one of the following in order to participate in the positioning session
Receiving response from at least one of the second UE, wherein the response of second UE indicates at least one parameter indicating the performance and/or quality parameter supported by second UE with respect to session management capabilities;
Creating a secure link (integrity protected and/or ciphered) for transmitting signaling message between the session coordinator UE and itself;
Monitoring the usage of resources and/or providing information to at least one other UE regarding the resource occupancy observed by the target UE;
Receiving a request from the coordinating UE, on behalf of a second entity, wherein the target UE either accepts or rejects the location request from the session coordinator;
Discovering at least one server UE handling the positioning session on behalf of the target UE, and selecting one UE to manage its positioning session;
Acting as assistant UE (attempt to perform ranging with the second UE if its identifier is known or use a configuration of resource in a discovery pool, transmit pool or exceptional pool to attempt to range with another UE);
performing measurement on resource pools configured and/or preconfigured to contain sidelink positioning reference signal;
assigning the session identifier and including it in the SLPP message sent to the anchor UE;
providing the session identifier to other UEs and LMF, so that the LMF is able to associate the measurements from other anchor UEs or server UEs to the measurement pertaining to the target UE, where the positioning calculation is done at the LMF side;
using the session identifier received from a second UE in all of the messages exchanged between the target UE and the second UE, which may be an anchor UE or a server UE, so that the messages associated with the positioning of the said target UE can be distinguished from the messages associated with positioning of other UE.

8. Target UE according to claim 1, wherein monitoring is performed so as to find one or more UE acting as positioning session coordinator, especially by
making use of pre-configured assistance data or pre-configured configuration data or pre-configured validity condition information, and/or
sending request to one or more UE acting as positioning session coordinator; and/or
sending request to one or more UE acting as positioning session coordinator to create and/or maintain a positioning session with an anchor UE or the add/deactivate/change an anchor UE in the positioning session; and/or
sending discovery message so as to find one or more UE acting as positioning session coordinator, especially sending discovery message transmitted in PSSCH where the SCI contains a Layer-2 Destination ID.

9. Target UE according to claim 1, wherein the transceiver is configured to initiate a positing session or a session less ranging and/or positioning operation using configured or pre-configured assistance data, wherein the assistance data at least describes a configuration of reference signal and/or a resource within a resource pool carrying a reference signal; and/or
wherein assistance data comprising one of the following location of the anchor UE (e.g. coordinates in local or global coordinates), information indicating the motion status of the anchor UE (e.g. in motion or stationary, or velocity), or information about positioning server UE and/or an assistant UE, or configuration of reference signals, or configuration of resources in transmit/receive/discovery/exceptional pool, or validity information of the provided assistance data (e.g. validity area and/or validity time and/or validity conditions or information regarding the transmit and receive pools configured for a UE within a sidelink bandwidth part); and/or
wherein assistance data are assigned to an area and/or are to be used by an UE/group of UEs being or traveling through the area;
wherein validity condition information comprising any one of the following V2X Area, Portion of a cell, Group of cells, spatial validity, temporal validity, validity based on measurement conditions.

10. Target UE according to claim 1, wherein the transceiver is configured to communicate with two different server UE managing two different poisoning sessions and/or participate at different poisoning sessions.

11. Target UE, comprising a transceiver and a controller,
wherein the transceiver is configured to receive positioning request (from its higher layers or from a second entity),
wherein the controller is configured to create and/or maintain a positioning session for a target UE, wherein the positioning session comprises at least a measurement between the target UE and an anchor UE; to select out of a plurality of UEs at least one anchor UE fulfilling one or more anchor UE selection criteria
to coordinate assignment of at least one resource for transmission and/or for reception with the target UE and the anchor UE involved in the positioning session, wherein coordinating assignment comprises exchanging resource information on at least one resource to be used for transmitting and/or receiving a positioning reference signal;
wherein the transceiver is configured to participate in a positioning session.

12. Anchor UE comprising a transceiver, wherein the transceiver is configured to exchanges information with another UE so as to coordinate with the another UE acting as positioning session coordinator,
wherein the information comprises one or more anchor UE selection criteria and/or at least one resource where the UE is able to transmit and/or receive sidelink positioning reference signals; and/or
wherein the information comprises a configuration, wherein the configuration indicates at least one resource configured by the other UE where it is configured to transmit and/or receive positioning reference signals; and/or
wherein the transceiver is configured to transmit and/or receive a reference signal for the positioning session using the at least one configuration an information on which is exchanged; and/or
wherein the transceiver is configured to transmit and/or receive a reference signal so as to participate in a positioning session, wherein the anchor UE associates at least two messages associated with the positioning of the target UE to a positioning session maintained by the other UE.

13. The anchor UE according to claim 12, wherein the UE uses the session identifier assigned by a second UE (server UE or a target UE), to associate at least two messages carrying assistance data and/or measurement pertaining to the target UE between a group of UEs participating in a positioning session and/or at the LMF.

14. Anchor UE according to claim 12, wherein the anchor UE is configured to sent or broadcast or unicast information, especially assistance information regarding its position, position accuracy, and/or movement, etc., to be used by the server UE as part of the anchor UE selection criteria or as indication to the server UE regarding its capability to serve as anchor UE; or
wherein an information, especially assistance information regarding its position, position accuracy, and/or movement, etc., to be used by the server UE as part of the anchor UE selection criteria or as indication to the server UE regarding its capability to serve as anchor UE is transmitted or broadcasted by a network entity or a UE being part of the position session; and/or
wherein an information to be sent or broadcasted or unicasted within the network comprises at least one of:
Position of the UE (to be uses as anchor UE);
Position covariance of the UE (to be uses as anchor UE);
Velocity estimate of the UE (to be uses as anchor UE);
Sensor data (e.g. Accelerometer, Magnetometer, Tachometer) Reference signal used for detecting the anchor UE (e.g. used for monitoring);
Transmit and/or reception pools of UE (to be used as anchor UE);
QoS information.

15. Anchor UE according to claim 12, wherein the anchor UE is configured and/or is controlled by the server UE for or configured for performing a ranging to another anchor UE and/or target UE or measurement as part of the positioning session to another anchor UE and/or target UE.

16. Anchor UE according to claim 12, wherein the anchor UE is configured to perform at least one of the following:
Establishing secure link (integrity protected and/or ciphered) for transmitting signaling messages between the session coordinator UE and at least one other UE;
Monitoring the link between the target UE and itself with respect to at least one quality criteria;
Monitoring the link between the UE coordinating the session and itself with respect to at least one quality criteria;
Monitoring the usage of resources and/or providing information to at least one other UE regarding the resource occupancy observed by the anchor UE;
indicates its availability to act as an anchor for a positioning session either in response to a request from the session coordinator;
Sending a detach request to the session coordinating entity, as a result of monitoring or due to change in traffic activity in the target UE (e.g. target UE requiring to handle high priority traffic).

17. Target UE according to claim 1 or anchor UE according to claim 12, wherein the resources/configuration used for the positioning session is configured by the positioning session coordinator or pre-configured.

18. Target UE according to claim 1 or anchor UE according to claim 12, the target UE and/or the anchor UE being configured to monitor certain type of information is or resources in a receive resource pool configured for a UE configured with a certain Layer-2 Destination ID; and/or
wherein the Layer-2 Destination ID being based on type of service; area; UE-identifier; session ID; group ID; function and/or UE-role.

19. Server UE, especially UE acting as positioning session coordinator, comprising a transceiver and a controller,
wherein the transceiver is configured to receive positioning request (from its higher layers or from a second entity),
wherein the controller is configured
to initiate and/or maintain a positioning session for a target UE, wherein the positioning session comprises at least a measurement between the target UE and an anchor UE;
to select out of a plurality of UEs at least one anchor UE fulfilling one or more anchor UE selection criteria; and
to coordinate assignment of the configuration associated with at least one resource for transmission and/or for reception with the target UE and the anchor UE involved in the positioning session.

20. UE (Target or Server UE) acting as positioning session coordinator according to claim 1 or 19, wherein the request comprises a discovery message or positioning session establishment request; and/or
wherein the transceiver is configured to respond to a discovery message by use of a discovery response message if the server UE is capable of acting as positioning session coordinator or to respond to a positioning session establishment request by use of a positioning session establishing response if the server UE has created a positioning session.

21. UE (Target or Server UE) acting as positioning session coordinator according to claim 1 or 19, wherein server UE is selected out of a plurality of UEs by a network entity, like the base station and/or location management function and/or access and mobility function, configured or pre-configured to act as a server UE; and/or
wherein the selection is done by using assistance data provided by the network via another UE in coverage, wherein the assistance data may indicate the availability of a server UE in a certain validity area; and/or
wherein the selection of the server UE is performed based on server selection criteria out of the following:
group membership of a group or moving group comprising the target UE and the server UE to be selected;
pre-configured and/or configured by the network;
Location (absolute or relative) of the server UE to be selected;
selected by the target UE taking into account its own location;
mobility state of the target UE and/or server UE to be selected;
association to same serving PLMN, to same type of service as indicated by application layer, to same OEM, etc;
synchronization reference of the server UE (SyncRef UE);
Energy considerations at the server UE;
Coverage and/or connectivity state of the server UE;
Number of anchors currently managed by the UE;
DOP value for a given location;
Latency values on signalling link;
QoS classes pertaining to positioning supported by the server UE;
Support of session handover by the server UE;
Condition that the server UE is in coverage or in partial coverage.

22. UE (Target or Server UE) acting as positioning session coordinator according to claim 1 or 19, wherein the request is sent as broadcast and/or groupcast messages by the target UE or as discovery message sent by the target UE; and/or
wherein the transceiver is configured to respond to the request, especially by providing a capability information; and/or
wherein the transceiver is configured exchange keys while establishing security.

23. UE (Target or Server UE) acting as positioning session coordinator according to claim 1 or 19, wherein the transceiver is configured to indicate its capabilities to act as an anchor UE, or positioning session coordinator UE, or ranging peer UE or as an assistance UE, or
wherein the transceiver is configured to indicate its capabilities to act as an anchor UE, or positioning session coordinator UE, or ranging peer UE or as an assistance UE, wherein an indication information is provided as one of the following:
in response to capability request, as unicast;
in response to discovery request, as unicast;
unsolicitated as unicast, broadcast or groupcast.

24. UE (Target or Server UE) acting as positioning session coordinator according to claim 1 or 19, wherein the selection done by the server UE based on information of anchor UE already available at the server UE (e.g. from network provisioning, preconfigured and/or configured assistance data, broadcast of information from network and/or anchor UE) or received by the server UE (e.g. assistance data sent by the one or more anchor uEs regarding its position, position accuracy, movement, etc.), where the information comprises a parameter which is used by the UE to select an anchor node or comprises indication to the server UE regarding a capability of another UE to serve as anchor UE.

25. UE (Target or Server UE) acting as positioning session coordinator according to claim 1 or 19, wherein the selection done by exchanging (receiving and/or sending out) a discovery message and/or a session creation request, where the messages indicate the parameters which form part of anchor UE selection criteria, such that the anchors fulfilling the request respond back to the server UE.

26. UE (Target or Server UE) acting as positioning session coordinator according to claim 1 or 19, wherein the one or more anchor UE selection criteria comprise a quality of service parameter; and/or wherein the one or more anchor UE selection criteria comprise a quality of service parameter and wherein the quality of service parameter comprise one of accuracy, latency, update rate, integrity (protection level, alert limit, time to alert).

27. UE (Target or Server UE) acting as positioning session coordinator according to claim 1 or 19, wherein anchor UE selection criteria comprise at least one out of a group comprising:
resources; and/or
method for a positioning session to be supported by the anchor UE;
RSRP on certain sidelink reference signal measured by the UE is: Below a configured threshold or above a configured threshold or below a first configured threshold and above a second configured threshold;
physical channel condition especially LOS condition, multipath, signal strength, RSRP measured, Latency observed on a signalling link;
belonging to a group of UEs that transverse through different areas;
within Range of the of the target UE and/or UE acting as positioning session coordinator;
privacy requirements;
security requirements;
Anchor role supported by the UE;
Line of sight condition between the target UE and the anchor UE;
estimate LOS condition based on this discovery signal, and associate the response;
Bandwidth of the positioning reference signal which can be transmitted and/or received by the UE;
Update rate supported by the anchor UE;
intended measurements (e.g. RSTD, RTT, TDOA, TOA, AoA, AoD) supported by the anchor UE;
Capability of the anchor UE to process sidelink measurements;
Location of the anchor UE;
Mobility state of the target UE and/or anchor UE and/or server UE;
Group Membership of the target UE and/or the anchor UE and/or anchor UE;
Synchronization reference of the anchor UE (SyncRef UE);
Energy considerations at the anchor UE;
Coverage and/or connectivity state of the anchor UE;
Latency values on signaling link.

28. UE (Target or Server UE) acting as positioning session coordinator according to claim 1 or 19, wherein the transceiver is configured to obtain at least one positioning measurement from at least one of the target UE and the anchor UE involved in the positioning session.

29. UE (Target or Server UE) acting as positioning session coordinator according to claim 1 or 19, wherein the UE or a location server are configured to compute the position based on a position measurement from at least one of the target UE and the anchor UE involved in the positioning session; or
wherein the UE or a location server are configured to compute the position based on a position measurement from at least one of the target UE and the anchor UE involved in the positioning session, wherein the position measurement is associating with the session identifier.

30. UE (Target or Server UE) acting as positioning session coordinator according to claim 1 or 19, wherein the request includes at least a quality of service parameter; and/or
wherein the request is received from a network entity, such as LMF or NG-RAN node or application function residing in core network, or another UE without sidelink transmission/reception capabilities, or another UE without sidelink transmission/reception capabilities at least for positioning reference signals, or another UE with sidelink, or a target UE; and/or
wherein the UE is configured to respond a target UE indicating its availability to act as positioning session coordinator or to respond a target UE indicating its availability to act as positioning session coordinator, wherein response comprise additional information such as RSRP measured on a reference signal associated with discovery message and/or additional information indicated by a discovery message, processing capability, e.g. number of position fixes per unit time, number of other uEs within its reach, current load, associated area.

31. UE (Target or Server UE) acting as positioning session coordinator according to claim 30, wherein the quality of service parameter comprises an information on one of accuracy, latency, update rate, integrity (e.g. protection level, alert limit, time to alert).

32. UE (Target or Server UE) acting as positioning session coordinator according to claim 1 or 19, wherein the positioning session associates at least two messages exchanged between the positioning session coordinator and at least one other UEs.

33. UE (Target or Server UE) acting as positioning session coordinator according to claim 1 or 19, wherein creating and/or maintaining a positioning session comprises one of the following:
Monitoring the selection of anchor UE with respect to performance criteria;
Monitoring the selection of anchor UE with respect to performance criteria, wherein the performance criteria are out of a group:
Monitoring the physical channel conditions between the target UE and the anchor UE (physical channel conditions may be LOS condition, multipath, signal strength)
Monitoring the signaling connections between the anchor UE and the server UE (RSRP measured on at least one reference signal on a signaling link, Latency observed on a signaling link)
Monitoring the geographical location of target and/or anchor (e.g. the angle between the target UE and the anchor UE);
Adding or removing an anchor involved on positioning session, based on the result of monitoring and/or monitoring outside the session;
Discovering a UE that can act as an anchor UE;
Discovering UE indicating its role as Located UE (if it is authorized to be a Located UE in a given PLMN);
Establishing secure (security and integrity protected) connection on signaling links;
Checking the whether the anchor UE is allowed to range with the target UE and/or vice versa;
Configuring the anchor UE to perform reporting, either on a periodic, based on a trigger or event-driven based on measurement;
Allocating or determining resources for the anchor UE and/or the target UE and/or interacting with the anchor UE and/or the target UE to identify a configuration of resource for performing channel measurement between two UEs;
performing measurement on resource pools configured and/or preconfigured to contain sidelink positioning reference signal.

34. UE (Target or Server UE) acting as positioning session coordinator according to claim 1 or 19, wherein the coordinating assignment comprise one of the following:
Providing at least one configuration to at least one UE, where the configuration indicates at least the time frequency resources such as bandwidth and periodicity.
Reconfiguring the provided configuration of transmit and/or receive resources provided to the UE.
Reconfiguring if the link becomes weak, for example, the update rate may be reduced and reporting disabled from the receiver until the link quality becomes better again; and/or
wherein the maintain a positioning session comprise (when entering a new area) monitoring and receiving information from one or more UE to act as anchor UEs, especially comprising monitored information (wrt changed parameters), and/or triggering one or more anchor UEs to perform a measurement and/or monitoring and to provide a report on the measurement and/or monitoring.

35. UE (Target or Server UE) acting as positioning session coordinator according to claim 1 or 19, wherein the controller is configured for one of the following:
Providing at least one UE the configuration to transmit and/or receive sidelink positioning signals;
associating at least two messages exchanged between the positioning session coordinator and at least one other UE,
monitoring the selection of anchor with respect to certain performance criteria.
adding or removing an anchor involved on positioning session, based on the result of monitoring and/or monitoring outside the session;
Reconfiguring the provided configuration of transmit and/or receive resources provided to the UE;
Initiating discovery procedure for discovering at least one target UE and/or at least one anchor UE;
Establish secure link (integrity protected and/or ciphered) for transmitting signalling messages between the session coordinator UE and at least one other UE;
Receiving the report from at least one other UE regarding the resource occupancy observed by the said UE;
Monitoring signaling latency between itself and another UE;
Checking whether the LCS client is allowed to make request regarding the target UE, by interacting with higher layer or with location server;
Checking whether the anchor UE is allowed to range with the target UE;
Providing an identifier, with which the messages from a positioning session can be identified by a second entity (e.g. a UE and/or a network entity). Determining a position based on the measurements obtained from at least one other UE;
Provide the location service to the LCS client;
Discovering at least one server UE, and handing over to the server UE, preferably before the target UE loses connectivity with the server UE;
Creation of a session for a given target UE;
Adding anchor UEs;
Removing anchor UEs;
Adding configuration pertaining to transmission and/or reception for a UE;
Establishing quality-of-service constraints with one or more uEs;
Assigning priorities to transmission and/or reception of positioning reference signals;
Acting as assistant UE (attempt to perform ranging with the second UE if its identifier is known or use a configuration of resource in a discovery pool, transmit pool or exceptional pool to attempt to range with another UE);
announcing its capabilities to act as a positioning session coordinator UE.

36. UE (Target or Server UE) acting as positioning session coordinator according to claim 1 or 19,
wherein the transceiver is configured to receive at least a measurement from at least an anchor and a target, and use the measurement for monitoring and/or computing position of the target UE; and/or
wherein the controller is configured to reselect anchors and/or reconfigure transmit and receive positioning resources for target UE, dependent on the measurement results; and/or
wherein the server UE is configured to report back to the entity requesting the location of the target UE (where the report consists at least of the requested location service); and/or
wherein the server UE to report back to the entity requesting the location of the target UE, where the report further contains indication of achieved QoS parameter and/or a flag indicating whether the QoS service was met.

37. UE (Target or Server UE) acting as positioning session coordinator according to claim 1 or 19, wherein server UE is formed by a separate server UE (variant 2) or a target UE (variant 1) or an assistant UE.

38. UE (Target or Server UE) acting as positioning session coordinator according to claim 1 or 19, wherein the server UE is requested and/or selected by target UE; and/or
wherein the server UE is selected under the condition that the target as well as the anchor UE are configured to communicated with the UE acting as positioning session coordinator and/or taking into account privacy/security demands.

39. System comprising a server UE according to claim 19 and/or a target UE according to claim 1 and at least one anchor UE according to claim 12.

40. System according to claim 39, wherein at least one of or all of the UEs comprising server UE, target UE and one or more anchor UE are out of coverage or partially out of coverage;
wherein at least one of or all of the UEs comprising server UE, target UE and anchor UE communicating with each other using sidelink communications or PC5 communications;
wherein at least one of or all of the UEs comprising server UE, target UE and one or more anchor UE are moving so that the position to be determined in the positioning session comprises a relative position of the target UE with respect to the one or more anchor UEs.

41. Method for operating a target UE, especially UE acting as positioning session coordinator and target UE, comprising:
receiving positioning request (from its higher layers or from a second entity),
creating and/or maintaining a positioning session for a target UE, wherein the positioning session comprises at least a measurement between the target UE and an anchor UE;
selecting out of a plurality of UEs at least one anchor UE fulfilling one or more anchor UE selection criteria;
coordinating assignment of at least one resource for transmission and/or for reception with the target UE and the anchor UE involved in the positioning session, wherein coordinating assignment comprises exchanging resource information on at least one resource to be used for transmitting and/or receiving a positioning reference signal;
participating in a positioning session.

42. Method for operating a server UE, especially UE acting as positioning session coordinator, comprising:
receiving positioning request (from its higher layers or from a second entity), initiating and/or maintaining a positioning session for a target UE, wherein the positioning session comprises at least a measurement between the target UE and an anchor UE;
selecting out of a plurality of UEs at least one anchor UE fulfilling one or more anchor UE selection criteria; and/or
coordinating assignment of the configuration associated with at least one resource for transmission and/or for reception with the target UE and the anchor UE involved in the positioning session.

43. Method for operating a target UE comprising providing in response to a started positioning session information on one or more anchor UE selection criteria and to participate in a positioning session.

44. Method for operating anchor UE comprising:
exchanging information with another UE so as to coordinate with the another UE acting as positioning session coordinator,
wherein the information comprises one or more anchor UE selection criteria and/or at least one resource where the UE is able to transmit and/or receive positioning reference signals; and/or
wherein the information comprises a configuration, wherein the configuration indicates at least one resource configured by the other UE where it is configured to transmit and/or receive sidelink positioning reference signals; and/or
transmitting and/or receiving a reference signal for the positioning session using the at least one configuration an information on which is exchanged; and/or
transmitting and/or receiving a reference signal so as to participate in a positioning session, wherein the anchor UE associates at least two messages associated with the positioning of the target UE to a positioning session maintained by the other UE.

45. Computer program for performing one of the methods according to claims 41 to 44.
